(19) United States
(12) Patent Application Publication
(10) Pub. No.: US 2020/0015043 A1
(43) Pub. Date: Jan. 9, 2020

(54) UPLINK SERVICE ACCESS VIA A WIRELESS LOCAL AREA NETWORK (WLAN)

(71) Applicant: QUALCOMM Incorporated, San Diego, CA (US)

(72) Inventors: Abhishek Pramod Patil, San Diego, CA (US); Soo Bum Lee, San Diego, CA (US); George Cherian, San Diego, CA (US); Shivraj Singh Sandhu, Milpitas, CA (US); Jouni Kalevi Malinen, Tuusula (FI); Alfred Asterjadhi, San Diego, CA (US); Rolf De Vegt, San Francisco, CA (US); Andrew MacKinnon Davidson, Monte Sereno, CA (US)

(21) Appl. No.: 16/503,276

(22) Filed: Jul. 3, 2019

Related U.S. Application Data
(60) Provisional application No. 62/694,402, filed on Jul. 5, 2018.
(60) Provisional application No. 62/847,855, filed on May 14, 2019.

(51) Int. Cl. H04W 4/06; H04W 48/08

(52) U.S. Cl. CPC H04W 4/06; H04W 84/12; H04W 48/08

(57) ABSTRACT

This disclosure provide systems, devices, apparatus and methods, including computer programs encoded on storage media, for providing service connectivity to a service of a service provider via a wireless local area network (WLAN). Several service connectivity techniques are described. In some implementations, a first wireless device may establish a communication link with the AP to access the service. In some implementations, the first wireless device may be an internet of things (IoT) device, and may be a headless IoT device. The communication link may be established without the wireless device joining a Basic Service Set (BSS) of an access point (AP). The service connectivity may be implemented using broadcast services between an AP and the wireless device. The broadcast services may be used for uplink broadcast traffic from the wireless device to a service provider via the AP. The service connectivity techniques may support onboarding and security features.

### CROSS-REFERENCE TO RELATED APPLICATIONS

This Patent Application claims priority to U.S. Provisional Patent Application No. 62/694,402 filed Jul. 5, 2018, entitled “SERVICE ACCESS VIA A WIRELESS LOCAL AREA NETWORK (WLAN),” and U.S. Provisional Patent Application No. 62/847,855 filed May 14, 2019, entitled “UPLINK SERVICE ACCESS VIA A WIRELESS LOCAL AREA NETWORK (WLAN)”, both assigned to the assignee hereof. The disclosures of the prior Applications are considered part of and are incorporated by reference in this Patent Application.

### TECHNICAL FIELD

This disclosure relates generally to wireless communication, and more specifically, to broadcast service in a wireless network.

### DESCRIPTION OF THE RELATED TECHNOLOGY

A wireless local area network (WLAN) may be formed by one or more access points (APs) that provide a shared wireless communication medium for use by a number of client devices also referred to as stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

A STA may have a wireless connection (referred to as a wireless association, or just “association”) when it has authenticated and established a secure wireless session with the AP. A variety of devices may operate as a STA in a wireless network. For example, internet of things (IoT) devices may include traditional STAs as well as devices that were not traditionally intended to operate in a network. Examples of IoT devices include cameras, drones, wearable devices, home appliances, lighting systems, security system components, speakers, smart refrigerators, televisions, sensors, tracking devices, and the like. An IoT device may be a data-producing or data-consuming endpoint in a wireless network. Recently, the IEEE is considering new features and new connectivity protocols motivated by IoT deployments, as well as new applications for traditional STAs. A WLAN may implement new protocols to support onboarding, security, and connectivity for wireless devices. For example, it may be desirable for an AP to support broadcast services via a WLAN.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. In some implementations, the method may be performed by wireless communication device of a first station (STA). The method may include determining that a first access point (AP) of a wireless local area network (WLAN) supports an uplink broadcast service that enables the first STA to transmit uplink data to a first service of a first service provider without establishing a wireless association between the first STA and the first AP. The method may include transmitting an uplink communication from the first STA to the first service via the uplink broadcast service of the first AP.

Another innovative aspect of the subject matter described in this disclosure can be implemented in a wireless communication device for use in a first STA. In some implementations, the wireless communication device may be an IoT device. The wireless communication device may include at least one processor and at least one memory communicatively coupled with the at least one processor. The memory may store processor-readable code that, when executed by the at least one processor, may cause the wireless communication device to determine that a first AP of a WLAN supports an uplink broadcast service that enables the first STA to transmit uplink data to a first service of a first service provider without establishing a wireless association between the first STA and the first AP. The memory may store processor-readable code that, when executed by the at least one processor, may cause the wireless communication device to transmit an uplink communication from the first STA to the first service via the uplink broadcast service of the first AP

In some implementations, the methods and wireless communication devices may be configured to receive a service advertisement from the first AP, the service advertisement indicating that the first AP is capable of forwarding the uplink communication to the first service.

In some implementations, the methods and wireless communication devices may be configured to receive a beacon frame from the first AP that includes the service advertisement.

In some implementations, the methods and wireless communication devices may be configured to receive a generic advertisement service (GAS) message from the first AP that includes the service advertisement.

In some implementations, the methods and wireless communication devices may be configured to receive the service advertisement on a common channel associated with the uplink broadcast service.

In some implementations, the service advertisement includes a network access identifier (NAI) realm or a domain name associated with the first service.

In some implementations, determining that the first AP supports the uplink broadcast service includes detecting a service set identifier (SSID) associated with the first service.

In some implementations, determining that the first AP supports the uplink broadcast service includes at least one member selected from a group consisting of broadcasting a first frame from the first STA to indicate that the first STA supports a pre-configured service parameter for the first service, and receiving a beacon frame from the first AP that indicates that the first AP supports the pre-configured service parameter for the first service.

In some implementations, the methods and wireless communication devices may be configured to determine that a second AP supports a different uplink broadcast service associated with a second service and select the first AP in response to a determination that the first STA is associated with the first service.

In some implementations, the methods and wireless communication devices may be configured to transmit one or more broadcast frames from the first STA to a server associated with the first service via the first AP.

In some implementations, the methods and wireless communication devices may be configured to transmit a first message to the first AP, the first message including at least a client identifier for the first STA and a network access identifier (NAI) realm for the first service.

In some implementations, the first STA is a headless device that has pre-configured service parameters associated with the first service, and the pre-configured service parameters are associated with a first configuration of the first AP that remains consistent regardless of whether the first AP implements an additional configuration for the WLAN.

In some implementations, the uplink broadcast service includes a neighbor awareness network (NAN) protocol, and transmitting the uplink communication includes joining a NAN data link (NDL) with the first AP.

In some implementations, the NDL utilizes a pre-configured service parameter for the uplink broadcast service, the pre-configured service parameter providing uplink broadcast access for the first STA.

In some implementations, the uplink broadcast service includes an outside context of a basic service set (OCB) protocol, and transmitting the uplink communication includes transmitting one or more OCB wireless broadcast frames.

In some implementations, the uplink broadcast service includes an independent basic service set (IBSS), and transmitting the uplink communication includes determining that the first AP is operating the IBSS for the uplink broadcast service.

In some implementations, the methods and wireless communication devices may be configured to transmit the uplink communication without establishing a full wireless association between the first STA and the first AP.

Another innovative aspect of the subject matter described in this disclosure can be implemented in a method for wireless communication. In some implementations, the method may be performed by a wireless communication device of a first AP. The method may include providing an uplink broadcast service via a WLAN, wherein the uplink broadcast service enables a first STA to transmit uplink data to a first service of a first service provider without establishing a wireless association between the first STA and the first AP. The method may include receiving an uplink communication from the first STA via the uplink broadcast service. The method may include forwarding at least a portion of the uplink communication to the first service.

Another innovative aspect of the subject matter described in this disclosure can be implemented in wireless communication device for use in a first AP. The wireless communication device may include at least one processor and at least one memory communicatively coupled with the at least one processor. The memory may store processor-readable code that, when executed by the at least one processor, may cause the wireless communication device provide an uplink broadcast service via a WLAN, wherein the uplink broadcast service enables a first STA to transmit uplink data to a first service of a first service provider without establishing a wireless association between the first STA and the first AP. The memory may store processor-readable code that, when executed by the at least one processor, may cause the wireless communication device receive an uplink communication from the first STA via the uplink broadcast service and forward at least a portion of the uplink communication to the first service.

In some implementations, the methods and wireless communication devices may be configured to establish a first service set identifier (SSID) associated with the first service provider.

In some implementations, the methods and wireless communication devices may be configured to announce the first SSID in a broadcast message.

In some implementations, the methods and wireless communication devices may be configured to concurrently establish a second SSID associated with either a second service provider or with a local service of the WLAN.

In some implementations, the methods and wireless communication devices may be configured to transmit a service advertisement from the first AP, the service advertisement indicating that the first AP is capable of forwarding the uplink communication to the first service.

In some implementations, the methods and wireless communication devices may be configured to transmit a beacon frame from the first AP that includes the service advertisement.

In some implementations, the methods and wireless communication devices may be configured to transmit a generic advertisement service (GAS) message from the first AP that includes the service advertisement.

In some implementations, the methods and wireless communication devices may be configured to transmit the service advertisement on a common channel associated with the uplink broadcast service.

In some implementations, the service advertisement includes a network access identifier (NAI) realm associated with the first service provider.

In some implementations, the methods and wireless communication devices may be configured to determine that a first wireless device is attempting to communicate with the first service based, at least in part, on receiving a first message from the first STA, wherein the first message indicates that the first STA supports a pre-configured service parameter for the first service.

In some implementations, the methods and wireless communication devices may be configured to broadcast a beacon frame from the first AP that indicates that the first AP supports a pre-configured service parameter for the first service.

In some implementations, the methods and wireless communication devices may be configured to receive a service request message from the first STA, the service request message including at least a client identifier for the first STA and a network access identifier (NAI) realm for the first service provider.

In some implementations, the methods and wireless communication devices may be configured to forward the service request message to an authentication server of the first service provider and receive a service response message from the authentication server before forwarding the uplink communication.

In some implementations, forwarding the service request message to the authentication server includes sending the service request message to a proxy server and causing the proxy server to forward the service request message to the authentication server.

In some implementations, receiving the uplink communication includes receiving the uplink communication without establishing a full wireless association.

In some implementations, the uplink broadcast service includes a neighbor awareness network (NAN) protocol, and providing the uplink broadcast service includes creating a NAN data link (NDL) with the first STA.

In some implementations, the NDL utilizes a pre-configured service parameter for the uplink broadcast service.

In some implementations, the uplink broadcast service includes an outside context of a basic service set (OCB) protocol, and providing the uplink broadcast service includes receiving one or more OCB wireless broadcast frames.

In some implementations, the uplink broadcast service includes an independent basic service set (MSS), and providing the uplink broadcast service includes operating the IBSS for the uplink broadcast service.

In some implementations, the methods and wireless communication devices may be configured to receive a service provider profile for the first service provider, wherein providing the uplink broadcast service is based, at least in part, on the service provider profile.

In some implementations, the service provider profile includes at least one of a service provider identifier, network access identifier (NAI) realm, a filter setting, a forwarding setting, a traffic type filter, a bandwidth limitation, or a security configuration.

In some implementations, the methods and wireless communication devices may be configured to include at least part of the service provider profile in a service advertisement.

In some implementations, the methods and wireless communication devices may be configured to establish a plurality of service provider relationships between the first AP and a plurality of service providers. In some implementations, the methods and wireless communication devices may be configured to transmit a service advertisement from the first AP, the service advertisement indicating that the first AP is capable of providing service connectivity to the plurality of service providers.

In some implementations, the first AP has pre-configured service parameters associated with the first service, and the pre-configured service parameters are associated with a first configuration of the first AP that remains consistent regardless of whether the first AP implements an additional configuration for the WLAN.

In some implementations, the methods and wireless communication devices may be configured to append AP-provided data to the one or more wireless messages before forwarding the one or more wireless messages to the first service.

In some implementations, the AP-provided data includes at least one member of a group consisting of: location data, a date stamp, a timestamp, an AP identifier, and received signal strength data.

In some implementations, the first wireless device is a tracking device and wherein the first service is associated with tracking a location of the tracking device.

In some implementations, the tracking device is associated with goods that are transported through one or more transportation, shipping or distribution providers.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a pictorial diagram of an example wireless communication network.

FIG. 2 shows a pictorial diagram of an example wireless communication network that implements uplink broadcast service access.

FIG. 3A shows an example protocol data unit (PDU) usable for communications between an access point (AP) and a station (STA).

FIG. 3B shows an example field in the PDU of FIG. 3A.

FIG. 4 shows a pictorial diagram of an example system for providing multiple services.

FIG. 5 shows a pictorial diagram of an example system with service profiles.

FIG. 6A shows a pictorial diagram of an example wireless communication network using neighbor awareness networking (NAN) protocol for service connectivity.

FIG. 6B shows a pictorial diagram in which a NAN network may include different NAN Data Links (NDLs) to support different applications or services.

FIG. 6C shows a pictorial diagram of an example wireless communication network using an independent Basic Service Set (IBSS) for service connectivity.

FIG. 6D shows a pictorial diagram of an example wireless communication network using an “outside the context of a basic service set” (OCB) protocol for service connectivity.

FIG. 7 shows a message flow diagram illustrating example service connectivity techniques.

FIG. 8A shows a pictorial diagram of an example use case of a mobile tracking sensor utilizing uplink broadcast services.

FIG. 8B shows a pictorial diagram in which an AP may append additional information to a forwarded uplink message.

FIG. 9A shows a pictorial diagram in which multiple APs may support uplink broadcast services.

FIG. 9B shows a pictorial diagram in which different APs may differ in their support of uplink broadcast services.

FIG. 9C shows a pictorial diagram in which different APs may advertise their support of uplink broadcast services.

FIG. 9D shows a pictorial diagram in which a common channel may be used for broadcast services.

FIG. 10 shows a message flow diagram illustrating example uplink service connectivity techniques in an environment with multiple APs.

FIG. 11 shows a block diagram of an example wireless communication device.

FIG. 12A shows a block diagram of an example AP.

FIG. 12B shows a block diagram of an example STA.

FIG. 13 depicts a conceptual diagram of an example frame for broadcast services.

FIG. 14 shows a flowchart illustrating an example process for connecting to services.

FIG. 15 shows a flowchart illustrating another example process for providing service connectivity to services.

FIG. 16 shows a block diagram of an example wireless communication device for use in wireless communication.

Like reference numbers and designations in the various drawings indicate like elements.

### DETAILED DESCRIPTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G standards, among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal frequency division multiple access (OFDMA), single-user (SU) multiple-input-multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IoT) network.

As new uses and applications for wireless devices (such as wireless stations (STAs) and Internet of Things (IoT) devices) are developed, there is a demand for user-friendly and efficient network service connectivity for such devices. In traditional systems, a wireless device would establish a secure wireless association with an access point (AP) to communicate with a service. In this disclosure, service connectivity refers to the ability of a wireless device to communicate with a service via an AP, and may or may not include a secure wireless association between the wireless device and the AP. This disclosure discussed broadcast services (or broadcast service connectivity) in which the wireless device may transmit (or broadcast) an uplink communication using a broadcast services protocol with an AP such that the AP can accept and forward the uplink communication to a service.

Broadcast services or other improvements to wireless communication may enable onboarding, configuration, and management of wireless devices. In some scenarios, the broadcast transmissions may include an unsolicited downlink broadcast from an AP to a large number of wireless devices. Alternatively, broadcast services may enable uplink services for wireless devices that may or may not be wirelessly associated with the AP. In some scenarios, the wireless devices may execute a broadcast services application that is configured to send or receive broadcast transmissions without establishing a wireless session to the AP. For example, a wireless device may transmit an unsolicited uplink broadcast which is intended to be forwarded to another apparatus, such as a central resource or service provider network. The IEEE has recently begun working on a draft standard specification for enhanced broadcast services (eBCS) that may support uplink service for a wireless device (such as a STA or an IoT device acting as a STA, which may also be generally referred to as a STA herein).

Previous techniques for establishing a wireless connection (for example, a wireless association) between a wireless device and an AP may be ineffective, slow, or otherwise undesirable for some applications. For example, there may be an undesirable delay associated with establishing a full wireless association. New techniques for uplink broadcast service may enable connectivity, security, and service for wireless devices. In accordance with aspects of this disclosure, a wireless device may transmit an uplink broadcast intended for a service provider without establishing an authenticated session with an AP. The wireless device may expect or desire that the AP would forward the uplink broadcast to the service provider. For example, the wireless device may attempt to utilize any AP without concern for which AP receives and forwards the uplink communication. This scheme may be referred to as a blind uplink broadcast (by the wireless device) and a blind forward (by the AP). However, the use of a blind forward may leave a network open to security vulnerabilities, may overconsume available bandwidth, or may be exploited for a denial of service (DoS) attack (including a DoS attack on other connected networks). Therefore, in addition to providing service connectivity for wireless devices, it is desirable for a WLAN to provide security. For example, an onboarding protocol may provide source authentication as well as enable service connectivity for a particular service.

In this disclosure, various techniques are described for providing uplink access to a service (including third party services) via a WLAN. Some examples and descriptions of techniques in this disclosure may especially benefit IoT devices, but aspects of the described techniques also may be used with STAs that are not considered IoT devices. Use of terms such as STA, IoT device, client device, or wireless device may be interchangeable in some implementations. Similarly, the techniques may be described in terms of IoT services, while the techniques may be used with other types of services from service providers. Services may refer to applications that are provided by an entity associated with transportation, home security, home automation, information services, among other examples. A service may include a server-based application (including a cloud-based application) that is hosted at the service provider. Examples of a service may include a manufacturer-provided online service to configure or update software for an IoT device (such as a network-enabled appliance, smart vehicle, industrial machine, among other examples). For example, a network-enabled appliance may obtain software updates, configurations, scheduling information, among other examples, from the service. Some IoT devices may be capable of providing status updates, error condition information, location information, or utilization information to the service for subsequent analysis or review by a user of the service. Another example of a service may include a vendor-served digital coupons in a mall or retail location. An IoT device (such as a kiosk or user device such as a mobile smartphone) may access the service to obtain digital coupons. Another example of a service may be provided by a taxi service provider. For example, a wireless device (such as a kiosk, IoT device, wearable device, user device, among other examples) may access the service to schedule a taxi pickup or to check status. Other examples of a service may include a home automation platform, home security monitoring and control service, a digital personal assistant, a gateway service, among other examples.

The service connectivity techniques may enable a wireless device to communicate with a service provider via an AP of a WLAN, and in some implementations, without completing an association with the AP. The service provider may be a centralized resource or entity (including a service which may be referred to as a “cloud” based service). Meanwhile, the AP may be owned, operated, or managed by another entity different from the service provider. Using the service connectivity techniques in this disclosure, a wireless device can establish a communication link with the AP in coordination with authentication, authorization, or accounting (AAA) provided by the service provider. Furthermore, the AP may implement a service provider profile associated with the service provider. The service provider profile may implement security policies or connectivity settings that are specific to the service provider. For example, the security policies may control the level of access, amount of bandwidth, or type of traffic that can be sent via the AP to the service provider. In some implementations, the wireless device may be a headless device that is in an unassociated state with respect to the AP. A wireless device that lacks a graphical user interface may be referred to as a headless device. Examples of headless devices may include sensors, light bulbs, cameras, actuators, appliances, game controllers, audio equipment, tracking devices or other communication devices that are capable of communicating via the network but which may not have a graphical user interface due to design.

In some implementations, an AP may append information to an uplink communication received from a STA before forwarding the uplink communication to an intended destination, such as a server. For example, an uplink communication from a wireless device (such as a tracker or sensor) may be received by the AP with an address of the intended destination (such as a service provider). The AP may append additional information that may be useful to the service provider. Examples of the additional information may include location information, a date or timestamp, an access point identifier, among other possibilities. In some implementations, such appended information may be used for tracking the location of a wireless device such as a sensor or tracker. For example, a wireless device may broadcast an uplink communication for any available APs to forward to a service provider. In some examples of this disclosure, the wireless device may be a tracker or other sensor, and the terms may be used interchangeably. The tracker may be a low-power or low-cost device that may not include a location determination unit (such as a Global Positioning System (GPS) module). However, the AP may append location data (such as a physical address, GPS data, among other examples) to the uplink communication when forwarding the uplink communication to the service provider. The AP also may append a timestamp or other data useful for the service provider. The service provider may be able to track the location of the tracker (and any associated equipment) based on the appended information and the uplink communication. Such techniques may be useful to track location of personal gear, appliances, shipments of goods, among other examples.

In some implementations, an AP may append information based on a request from the wireless device (such as a sensor device). For example, the wireless device may include an element, a field, a bit, or other indicator in the uplink transmission to the AP to inform the AP that the wireless device needs additional service from the AP. The element, field, bit, or indicator may cause the AP to append particular information to the uplink transmission before forwarding the uplink transmission to a service provider. In some implementations, the element, field, bit or other indicator may specify the type of information that the wireless device would like the AP to append. For example, a first value “0” may indicate no additional data should be appended, a second a second value “1” may indicate a request for the AP to append location data, a third value “2” may indicate a request for the AP to append a data stamp or a time stamp, a fourth value “3” may indicate a request for the AP to append RSSI information. The example values and defined meanings may be altered in various implementations. Other types of data or services may be indicated by additional values.

In some implementations, the AP may determine the type of AP-provided data to append based on the destination service provider to which the packet is being forwarded. For example, the AP may determine that the destination service provider is a first entity that utilizes a particular type of AP-provided data. The AP may determine the first entity based on, for example, a destination address for the uplink transmission. The AP may determine a type of AP-provided data to append to the uplink transmission based on a predetermined configuration, relationship, or profile associated with the first entity. For example, when forwarding an uplink transmission to a first entity, the AP may append location data, but when forwarding an uplink transmission to a second entity, the AP may append a timestamp. In some implementations, the wireless device may not indicate an exact type of information to append but rather may include an indication that it needs the AP to append basic information. The AP may interpret the indication as a request to include basic information such as a datestamp, a timestamp, an RSSI value, among other examples. In some implementations, a media access control (MAC) layer of the AP may provide the AP-provided information as a service parameter to a higher layer (such as through a MAC service access point (MAC-SAP) interface). The higher layer may then append the AP-provided information to the uplink transmission before forwarding the uplink transmission to the destination service provider. In some implementations, the AP may append the AP-provided information as a MAC Service Data Unit (MSDU) which is passed to the higher layer. In such case, the higher layer may process the MSDU as though it came from the originating wireless device. The format in which the AP provides the AP-provided information may be standardized or may be specific to the destination service provider.

In some implementations, an AP may advertise that it has the capability to provide connectivity to a service. For example, the AP may transmit service advertisement messages or other messages indicating which services it supports. A wireless device may select the appropriate service based on a relationship between the wireless device and the service provider. In some implementations, the AP may provide a broadcast service which permits uplink broadcasts from authenticated wireless devices (which may not be in associated states with respect to the AP). In some implementations, the service connectivity techniques may be used to establish an affiliate or subscription relationship between the AP and the wireless device. In some implementations, the AP may not operate a Basic Service Set (BSS) or may utilize broadcast services without establishing a BSS association.

Different broadcast services may be adapted or modified to support wireless services (including those that may be specific to IoT devices). For example, in some implementations, the broadcast connectivity may include the use of pre-configured settings, a neighbor awareness network (NAN) protocol, an “outside the context of a BSS” (OCB) protocol, or an independent BSS (IBSS) protocol. An example of pre-configured settings (which also may be referred to as pre-configures service parameters) may include parameters (such as authentication, capability, identifiers, among other examples) to establish a wireless association without performing a negotiation or exchange of such parameters. The protocols may be modified to support broadcast connectivity between an AP and a wireless device or between two peer wireless communication devices (such as between two IoT devices or between an IoT device and a traditional STA). Some implementations of broadcast services may support uplink broadcast transmissions from an IoT device (such as a sensor) to an AP. For example, in some implementations, the broadcast connectivity technique may utilize pre-configured settings to establish a communication link. The wireless device may broadcast uplink data to the AP via the communication link, and the AP may be configured to forward the uplink data to a central resource (such as a service provider network, central controller, server, among other examples).

Particular implementations of the subject matter described in this disclosure can be implemented to realize one or more of the following potential advantages. Wireless devices can be deployed using new onboarding and service connectivity techniques. Adoption of new types of IoT devices can be more user friendly as a result of the efficient onboarding. Security can be implemented by an AP based on service provider profiles, and as such, the risks to the WLAN and the upstream networks can be mitigated. Some of the implementations also can enable seamless onboarding with little or no user configuration.

For brevity, in this disclosure several examples are described in terms of a STA and an AP. However, the broadcast services described in this disclosure can be used by different types of devices, such as STAs, APs, or any combination of STAs and APs. For example, the AP described in this disclosure may be a STA performing the features of the described AP that is providing broadcast services for other STAs in a peer-to-peer, mesh, or other ad hoc logical hierarchical arrangement.

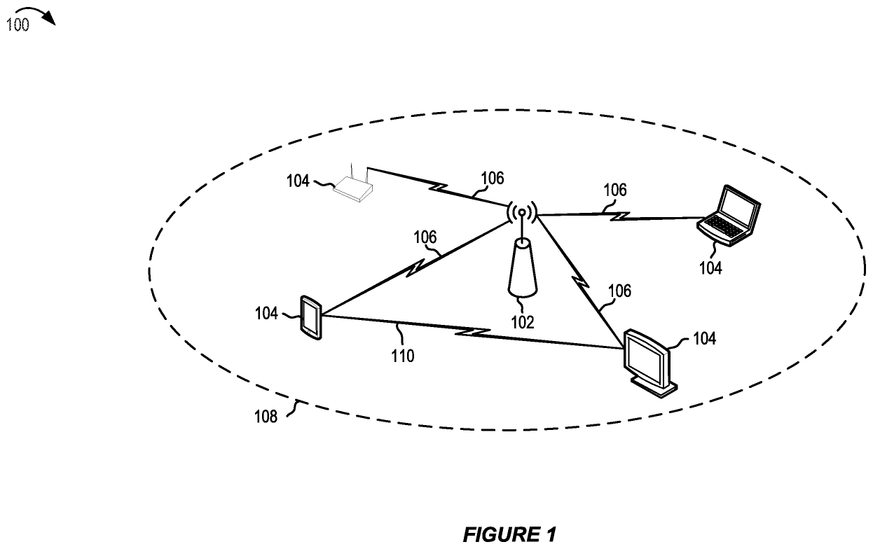

FIG. 1 shows a pictorial diagram of an example wireless communication network. FIG. 1 includes a block diagram of an example wireless communication network 100. According to some aspects, the wireless communication network 100 can be an example of a wireless local area network (WLAN) such as a Wi-Fi network (and will hereinafter be referred to as WLAN 100). For example, the WLAN 100 can be a network implementing at least one of the IEEE 802.11 family of standards (such as that defined by the IEEE 802.11-2016 specification or amendments thereof including, but not limited to, 802.11aa, 802.11ah, 802.11ad, 802.11aq, 802.11ay, 802.11ax, 802.11az, 802.11ba and 802.11be). The WLAN 100 may include numerous wireless communication devices such as an access point (AP) 102 and multiple stations (STAs) 104 that have a wireless association with the AP 102. In addition, there may be STAs (not shown) that do not have a wireless association with the AP 102. While only one AP 102 is shown, the WLAN network 100 also can include multiple APs 102.

Each of the STAs 104 also may be referred to as a mobile station (MS), a mobile device, a mobile handset, a wireless handset, an access terminal (AT), a user equipment (UE), a subscriber station (SS), or a subscriber unit, among other possibilities. The STAs 104 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 102 and an associated set of STAs 104 may be referred to as a basic service set (BSS), which is managed by the respective AP 102. FIG. 1 additionally shows an example coverage area 106 of the AP 102, which may represent a basic service area (BSA) of the WLAN 100. The BSS may be identified to users by a service set identifier (SSID), as well as to other devices by a basic service set identifier (BSSID), which may be a media access control (MAC) address of the AP 102. The AP 102 periodically broadcasts beacon frames (“beacons”) including the BSSID to enable any STAs 104 within wireless range of the AP 102 to establish a respective communication link 106 (hereinafter also referred to as a “Wi-Fi link”), or to maintain a communication link 106, with the AP 102. For example, the beacons can include an identification of a primary channel used by the respective AP 102 as well as a timing synchronization function for establishing or maintaining timing synchronization with the AP. The AP 102 may provide access to external networks to various STAs 104 in the WLAN via respective communication links 106. To establish a communication link 106 with an AP 102, each of the STAs 104 is configured to perform passive or active scanning operations (“scans”) on frequency channels in one or more frequency bands (for example, the 2.4 GHz, 5 GHz, 6 GHz or 60 GHz bands). To perform passive scanning, a STA 104 listens for beacons, which are transmitted by respective APs 102 at a periodic time interval referred to as the target beacon transmission time (TBTT) (measured in time units (TUs) where one TU may be equal to 1024 microseconds (μs)). To perform active scanning, a STA 104 generates and sequentially transmits probe requests on each channel to be scanned and listens for probe responses from APs 102. Each STA 104 may be configured to identify or select an AP 102 with which to associate based on the scanning information obtained through the passive or active scans, and to perform authentication and association operations to establish a communication link 106 with the selected AP 102. The AP 102 assigns an association identifier (AID) to the STA 104 at the culmination of the association operations, which the AP 102 uses to track the STA 104.

FIG. 1 additionally shows an example coverage area 108 of the AP 102, which may represent a basic service area (BSA) of the WLAN 100. As a result of the increasing ubiquity of wireless networks, a STA 104 may have the opportunity to select one of many BSSs within range of the STA or to select among multiple APs 102 that together form an extended service set (ESS) including multiple connected BSSs. An extended network station associated with the WLAN 100 may be connected to a wired or wireless distribution system that may allow multiple APs 102 to be connected in such an ESS. As such, a STA 104 can be covered by more than one AP 102 and can associate with different APs 102 at different times for different transmissions. Additionally, after association with an AP 102, a STA 104 also may be configured to periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 100. In such implementations, while the STAs 104 may be capable of communicating with each other through the AP 102 using communication links 106, STAs 104 also can communicate directly with each other via direct wireless links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless links 110 include Wi-Fi Direct connections, connections established by using a Wi-Fi Tunneled Direct Link Setup (TDLS) link, and other P2P group connections.

The APs 102 and STAs 104 may function and communicate (via the respective communication links 106) according to the IEEE 802.11 family of standards (such as that defined by the IEEE 802.11-2016 specification or amendments thereof including, but not limited to, 802.11aa, 802.11ah, 802.11aq, 802.11ad, 802.11ay, 802.11ax, 802.11az, 802.11ba and 802.11be). These standards define the WLAN radio and baseband protocols for the PHY and medium access control (MAC) layers. The APs 102 and STAs 104 transmit and receive wireless communications (hereinafter also referred to as “Wi-Fi communications”) to and from one another in the form of physical layer convergence protocol (PLCP) protocol data units (PPDUs).

Each of the frequency bands may include multiple sub-bands or frequency channels. For example, PPDUs conforming to the IEEE 802.11n, 802.11ac and 802.11ax standard amendments may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 520 MHz by bonding together multiple 20 MHz channels.

Each PPDU is a composite structure that includes a PHY preamble and a payload in the form of a PLCP service data unit (PSDU). For example, the PSDU may include a PLCP preamble and header as well as one or more MAC protocol data units (MPDUs). The information provided in the PHY preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

The communication link 106 may carry uplink broadcast transmissions from the associated STAs 104 to the AP 102. In some implementations, unassociated STAs (not shown) also may be capable of transmitting uplink broadcast communications to the AP 102 using broadcast connectivity techniques described in this disclosure.

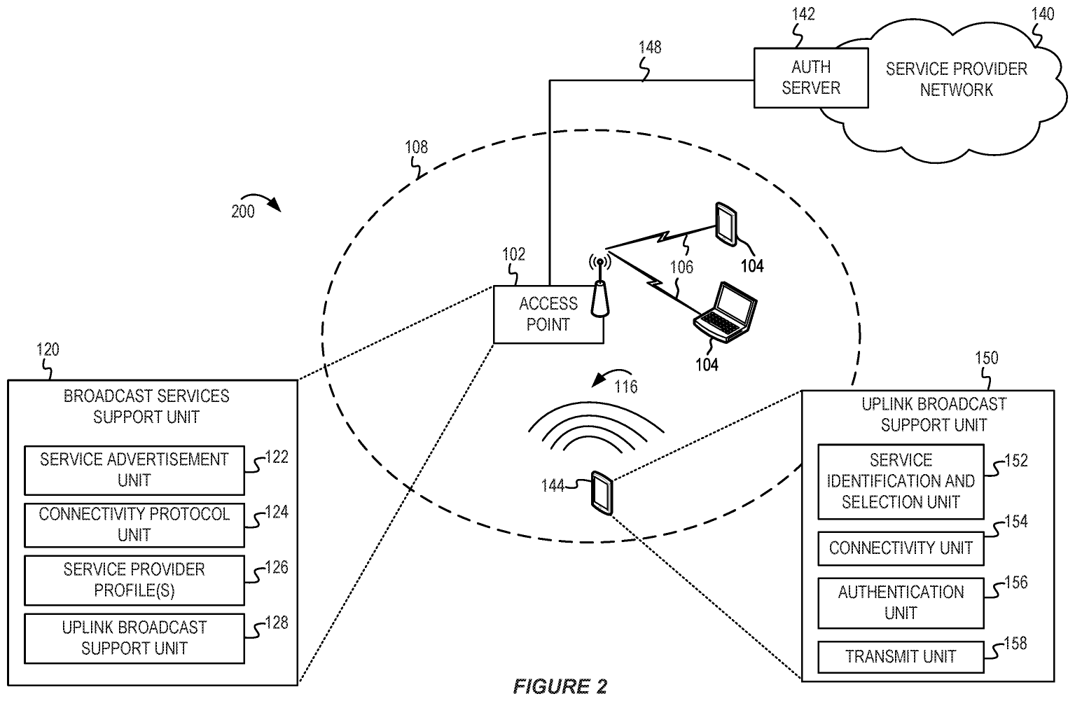

FIG. 2 shows a pictorial diagram of an example wireless communication network 200 that implements uplink broadcast service access. In FIG. 2, a wireless device 144 may be capable of communicating data via the AP 102 to a service provider network 140. For example, the wireless device 144 may be a STA or an IoT device, among other examples. The wireless device 144 may transmit uplink data via broadcast signals 116 to the AP 102 with the expectation that the AP 102 may forward the uplink data to the service provider network 140. The AP 102 may have a connection 148 between the AP 102 and the service provider network 140. The connection 148 may be wired or wireless and may include one or more intermediate networks (not shown). In accordance with some implementations of this disclosure, the service provider network 140 may include an authentication server 142. The authentication server 142 may be used to process a service request message from the wireless device 144 (via the AP 102). The AP 102 may coordinate with the authentication server 142 to implement authentication or other security features that are specific to the service provider.

The AP 102 may include a broadcast services support unit 120 configured to coordinate with one or more service providers and provide service connectivity to wireless devices to access the one or more service providers. The broadcast services support unit 120 may include a service advertisement unit 122. For example, the service advertisement unit 122 may provide service advertisements (also referred to as announcements) regarding which service providers the AP 102 may support. The broadcast services support unit 120 also may include a connectivity protocol unit 124. The connectivity protocol unit 124 may implement a service connectivity protocol to support access by wireless devices to the services. Service connectivity refers to an ability of a wireless device to communicate to a service (such as an upstream server or service provider network) via the AP 102. In some implementations, the service connectivity protocol may include a broadcast services protocol. For example, the connectivity protocol unit 124 may implement the NAN protocol, the OCB protocol, or the IBSS protocol with modifications to support broadcast services. The broadcast services support unit 120 may include one or more service provider profiles 126. In some implementations, the service provider profiles 126 may be configured on the AP 102 in response to establishing service connectivity for a wireless device 144. In some implementations, the service provider profiles 126 may be pre-configured on the AP 102 prior to establishing the service connectivity and may include settings used to establish the service connectivity for the wireless device 144. The service provider profiles 126 may include security policies, configuration settings, among other examples, and may be specific to each service provider supported by the AP 102. For example, the service provider profiles 126 may restrict the level or type of access that the wireless device 144 can use the AP 102 for. The service provider profiles 126 may set bandwidth utilization limits, filters for type of data, among other examples. The service provider profiles 126 also may indicate when and where messages can be forwarded by the AP 102 to the service provider network 140. The broadcast services support unit 120 also may include an uplink broadcast support unit 128. The uplink broadcast support unit 128 may be configured to receive uplink broadcasts from a wireless device 144 and to forward the uplink data to the service provider network 140. In some implementation, the uplink broadcast support unit 128 may coordinate with the connectivity protocol unit 124 to implement pre-configured service parameters to support the uplink broadcasts.

The wireless device 144 may include an uplink broadcast support unit 150 to implement one or more of the features described herein. The uplink broadcast support unit 150 may include a service identification and selection unit 152, a connectivity unit 154, an authentication unit 156, and a transmit unit 158. The service identification and selection unit 152 may determine whether the AP 102 is capable of providing connectivity to the service provider 140. In some implementations, there may be multiple APs (not shown) which provide one or more service connectivity options to the service provider network 140. For example, a wireless device may find multiple APs (not shown) in an airport that advertise a service connectivity option for transportation services (such as taxis, airlines, rental car companies, among other examples). In another example, a smart home appliance may be deployed in a residence where multiple APs (possibly including APs deployed at a neighboring location) may be capable of providing service connectivity for the smart home appliance to communicate with a service provider associated with the smart home appliance. In implementations where a wireless device may have multiple APs available for service connectivity, the service identification and selection unit 152 may select which AP to use for access to the service. The selection may be based on signal strength, user preferences, history of previous connections, channel utilization, or other criteria. For example, the service identification and selection unit 152 may maintain a history of previous connections and give greater preference for an AP that is most used or most recently used. In some implementations, the selection of which AP to use may be based on signal quality for the service without regard to a previous relationship between the wireless device and the AP.

Alternatively, or additionally, an environment may have one or more APs that support service connectivity to different service providers. The service identification and selection unit 152 may determine which AP(s) provide the service connectivity to the service provider for which the wireless device 144 is configured to use. For example, a single AP at an airport may advertise service connectivity for multiple rental car or taxi companies, while keeping traffic associated with each service separated at the AP. A wireless device may connect to a selected service based on which rental car or taxi company application is being executed on the wireless device.

The connectivity unit 154 may establish connectivity to the service provider via the AP 102. For example, the connectivity unit 154 may implement the modified connectivity protocol that is supported by the connectivity protocol unit 124. The authentication unit 156 may support authentication to the authentication server 142 via the AP 102. For example, the authentication unit 156 may send a service request message (or one or more message exchanges) that includes authentication information via the broadcast signals 116. The service request message may include a network access identifier (NAI) realm along with a client identification of the wireless device 144. In some implementations, the NAI realm may be preconfigured on the wireless device 144. In some implementations, the AP 102 may provide the NAI as part of a service advertisement.

The broadcast services support unit 120 may provide traffic separation. For example, the broadcast services support unit 120 may forward traffic destined to a particular service provider to that service provider, while keeping traffic destined to a different service provider separate. The services support unit 120 can limit access to other service unless the wireless device authenticates to the other service. In some implementations, the service provider may compensate the owner or operator of the AP 102 for providing the service to the wireless device. For example, the service provider may pay for internet services, costs of security software, commission, or other compensation in exchange for the AP 102 providing access to its service.

In some implementations, the AP 102 may provide a “common channel” that is known to support uplink service connectivity to the service provider. For example, the IEEE standard specification may specify one or more common channels that are designated for supporting uplink service connectivity. For example, there may be a subset of wireless channels (from among a plurality of wireless channels in a channel map) that are designated for eBCS or that are otherwise available for an AP to establish the uplink service connectivity described in this application. In some implementations, because the subset of wireless channels is a fixed list, the wireless device may scan the subset of wireless channels to quickly locate the uplink service connectivity (for forwarding uplink communications to a service provider). Alternatively, the wireless device may send an unsolicited broadcast on a common channel (from the subset of wireless channels designated for this service) such that any APs that support the uplink service can receive the unsolicited broadcast. The use of a common channel (or set of common channels) may improve the likelihood that the wireless device 144 can discover an AP 102 that supports the forwarding of uplink communications. In some implementations, this technique may be used with blind forwarding as well as authenticated or verified access.

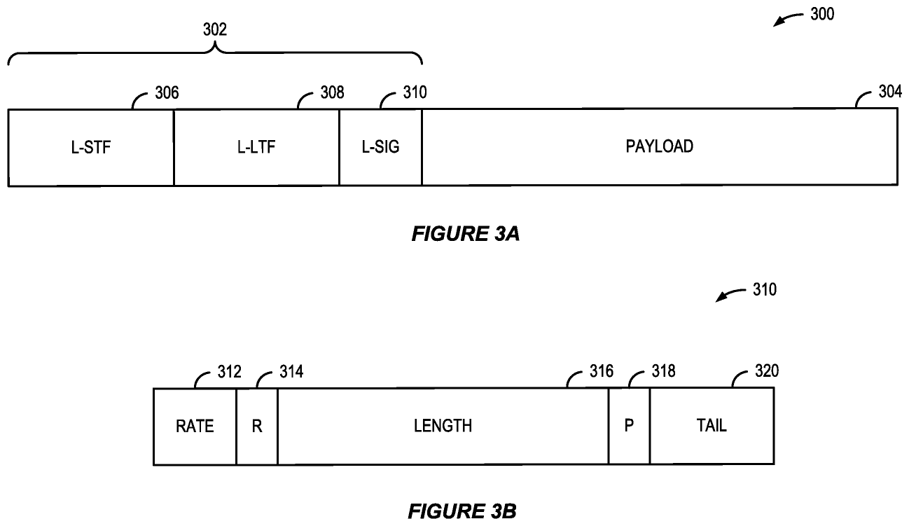

FIG. 3A shows an example protocol data unit (PDU) 300 usable for communications between an AP and a number of STAs. For example, the PDU 300 can be configured as a PPDU. As shown, the PDU 300 includes a PHY preamble 302 and a PHY payload 304. For example, the PHY preamble 302 may include a legacy portion that itself includes a legacy short training field (L-STF) 306, a legacy long training field (L-LTF) 308, and a legacy signaling field (L-SIG) 310. The PHY preamble 302 also may include a non-legacy portion (not shown). The L-STF 306 generally enables a receiving device to perform automatic gain control (AGC) and coarse timing and frequency estimation. The L-LTF 308 generally enables a receiving device to perform fine timing and frequency estimation and also to estimate the wireless channel. The L-SIG 310 generally enables a receiving device to determine a duration of the PDU and use the determined duration to avoid transmitting on top of the PDU. For example, the L-STF 306, the L-LTF 308 and the L-SIG 310 may be modulated according to a binary phase shift keying (BPSK) modulation scheme. The payload 304 may be modulated according to a BPSK modulation scheme, a quadrature BPSK (Q-BPSK) modulation scheme, a quadrature amplitude modulation (QAM) modulation scheme, or another appropriate modulation scheme. The payload 304 may generally carry higher layer data, for example, in the form of medium access control (MAC) protocol data units (MPDUs) or an aggregated MPDU (A-MPDU).

FIG. 3B shows an example L-SIG field 310 in the PDU of FIG. 3A. The L-SIG 310 includes a data rate field 312, a reserved bit 314, a length field 316, a parity bit 318, and a tail field 320. The data rate field 312 indicates a data rate (note that the data rate indicated in the data rate field 312 may not be the actual data rate of the data carried in the payload 304). The length field 316 indicates a length of the packet in units of, for example, bytes. The parity bit 318 is used to detect bit errors. The tail field 320 includes tail bits that are used by the receiving device to terminate operation of a decoder (for example, a Viterbi decoder). The receiving device utilizes the data rate and the length indicated in the data rate field 312 and the length field 316 to determine a duration of the packet in units of, for example, microseconds (μs).

In some implementations, a wireless communication device may use a generic advertisement service (GAS) message to indicate that the wireless communication device supports broadcast services. In some implementations, a wireless communication device may use GAS messages to communicate broadcast messages. The GAS message format may be extended or modified to support broadcast services. For example, a GAS message frame format may be modified or extended to include capability or configuration information related to broadcast services. In some other implementations, a new frame format may be created to facilitate uplink broadcast services.

In some implementations, the service advertisement unit 122 may transmit a message that includes a hash or hint payload that indicates the available broadcast services. For example, a hash payload may include hashed indicators for one or more broadcast services. A STA 144 may search the hash payload for a particular hash indicator associated with a desired broadcast service. Alternatively, a hint payload is similar to the hashed indicators except that the hint may include a portion of the hashed indicators to reduce the overhead associated with the payload of the service advertisement. For example, the hint payload may be a bloom filter representation of the services that are supported by the AP 102. The hashed or hint indicators may be sent by the AP 102 to indicate that the AP 102 has access to particular services. The STA 144 may utilize the AP 102 for a specific service identified in the hashed or hint indicators. Related to broadcast connectivity, an AP 102 may advertise access to one or more services which can be identified by the hashed or hint indicators. The STA 144 may determine to stay on a channel to listen for a broadcast frame from the AP 102 if the AP 102 has indicated (such as in a beacon frame or GAS frame) that the AP 102 supports a certain broadcast service. Alternatively, or additionally, a broadcast frame from the AP 102 may carry information (such as hint or hash) to let the STA 144 know which service is included in that broadcast frame. The STA 144 may determine whether to transmit an uplink broadcast frame depending on whether the AP 102 supports a particular service.

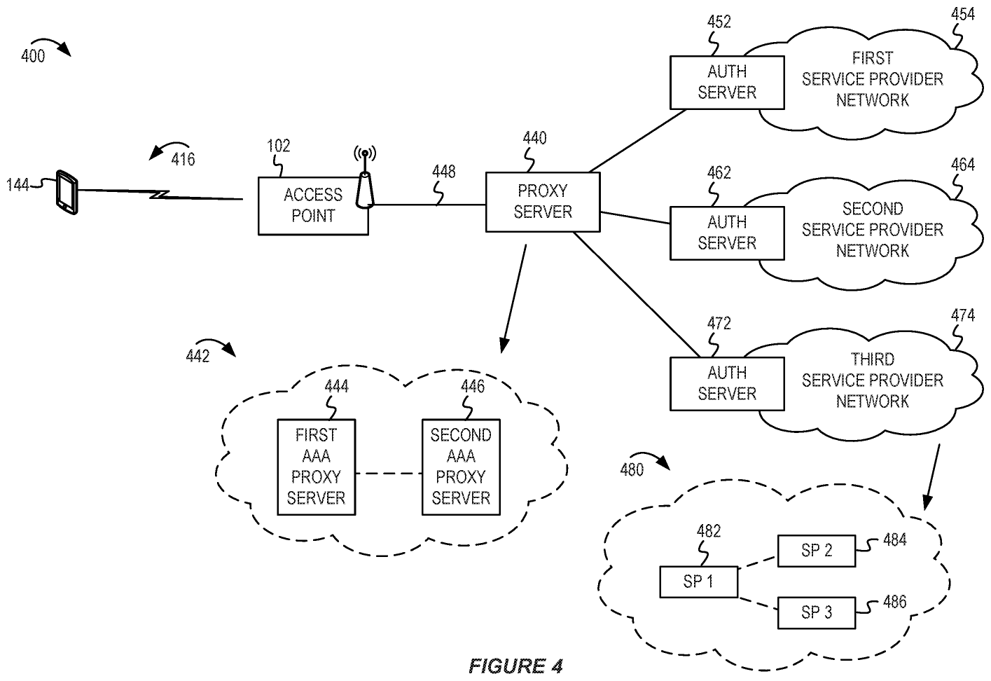

FIG. 4 shows a pictorial diagram of an example system 400 for providing multiple services. The example system 400 includes the wireless device 144 and the AP 102. Initially, the wireless device 144 may not have an association with, or otherwise have authorization to access, the AP 102. In the example of FIG. 4, the AP 102 may have relationships with multiple service providers. Examples of the service providers may include a telecommunications entity, a consumer technology entity, a cloud-based service provider, among other examples. FIG. 4 shows a first service provider network 454, a second service provider network 464, and a third service provider network 474. Each of the service provider networks 454, 464, and 474 may have different authentication servers 452, 462, and 472, respectively. The AP 102 may isolate traffic associated with each of the service provider networks 454, 464, and 474.

FIG. 4 shows some network design options to facilitate establishment of a relationship between the AP 102 and one or more service providers. For example, the AP 102 may be an AP in a home, apartment, coffee shop, hotel, or other location. The AP 102 may be operated and managed separately from the service providers. For example, a scenario may include the AP 102 being in a person's home and owned or managed by the person, while the service provider may be a separate entity (such as an alarm monitoring company, home assistance service, smart home service provider, among other examples). The AP 102 may utilize a proxy server 440 to assist with authentication or onboarding multiple service provider networks. The AP 102 may have a connection 448 with the proxy server 440, while the proxy server 440 may have different connections to the service provider networks 454, 464, and 474.

The wireless device 144 may determine that the AP 102 supports a particular service provider associated with the wireless device 144. For example, if the wireless device 144 is configured to send data to the first service provider network 454 (or receive data from the first service provider network 454), the wireless device 144 may determine whether the AP 102 is capable of providing service connectivity to the first service provider network 454. In some implementations, the wireless device 144 may broadcast a first message to request a response from any APs that support a particular service. In some implementations, the wireless device 144 may observe broadcast messages or advertisement messages from the AP 102 to determine whether the broadcast services support unit 120 supports the particular service.

During an authentication phase, the wireless device 144 may send a service request message that triggers an authentication between the wireless device 144 and the first service provider. For example, the service request message may be an authentication message, an EAP response/identity, or other type of message to initiate access to the service. In some implementations, the service request message may include a client identifier associated with the wireless device 144. The service request message also may include a NAI realm (or domain name) that identifies the first service provider network 454. The AP 102 may be configured to send the service request message to the proxy server 440. In some implementations, the AP 102 may modify or add information to the service request message. For example, the AP 102 may include some identity information, certificate, or signature to identify, register, or authenticate the AP 102 with either the proxy server 440 or the first service provider network 454. The proxy server 440 may forward the service request message to the appropriate service provider. For example, the proxy server 440 may inspect the NAI realm and determine to forward the service request message to the authentication server 452 associated with the first service provider network 454. In some implementations, the service request message may be formatted in accordance with the Remote Authentication Dial-In User Service (RADIUS) protocol. In some implementations, the authentication phase may include an extended authentication protocol (EAP) with the exchange of messages to perform a secure authentication of the wireless device 144. When the proxy server 440 receives a service response message, the proxy 440 may forward the service response message to the AP 102. In some implementations, there may be one or more message exchanges between the wireless device 144 and the proxy server 440 or the authentication server 452 before the service response message indicates that the service has been approved. Based on the service response message, the AP 102 may establish a communication link 416 to the wireless device 144 to provide service connectivity for the wireless device 144 to the first service provider network 454.

In addition to receiving the service response message, the AP 102 also may receive communication parameters (which are referred to herein as a service provider profile). The service provider profile may include information used to establish the communication link 416. For example, the service provider profile may include security parameters that correspond to pre-configured settings on the wireless device 144. In another example, the service provider profile may include information about how the AP 102 can communicate with the first service provider network 454. For example, the service provider profile may include a forwarding destination address, a bandwidth or rate limit, a filter settings (regarding the type of data that can be forwarded), among other examples.

Many variations of the network design may be possible. For example, a first variation 442 shows the proxy server 440 may include multiple proxy AAA servers, such as a first proxy AAA server 444 and a second proxy AAA server 446. The multiple proxy AAA servers may be redundant proxy servers or may be organized in a hierarchical manner. For example, the first proxy AAA server 444 may be implemented at a local internet service provider (local ISP) while the second proxy AAA server 446 may be implemented at an upstream ISP. The multiple proxy AAA servers may forward service request messages and service response messages in the hierarchical topology to provide an authentication path between the AP 102 and the authentication servers 452, 462, and 472.

A second variation 480 shows multiple service providers may be organized in a hierarchical manner. For example, a first service provider 482 may process service request messages on behalf of a second service provider 484 or a third service provider 486. The first service provider 482 also may coordinate the exchange of information to or from the wireless device 144 (via the AP 102 and the first service provider 482) to the second service provider 484 or the third service provider 486.

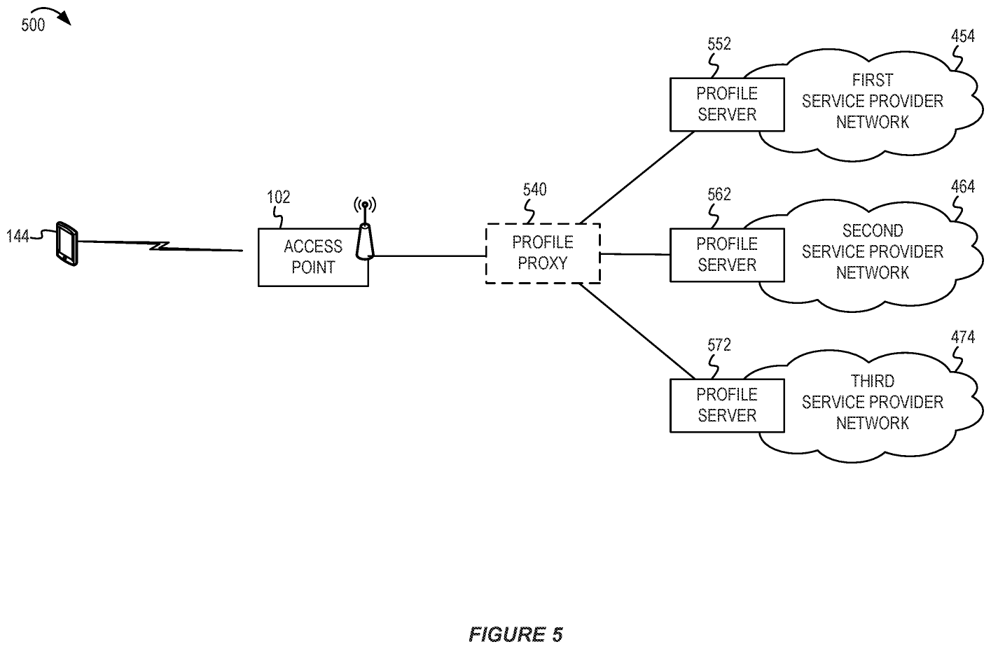

FIG. 5 shows a pictorial diagram of an example system 500 with service profiles. FIG. 5 includes the AP 102, the wireless device 144, the first service provider network 454, the second service provider network 464, and the third service provider network 474 as described previously. In FIG. 5 the service providers may install or share or otherwise provide service provider profiles with the AP 102. In some implementations, the AP 102 may request the service provider profiles from a profile proxy 540 or directly from profile servers 552, 562, and 572 corresponding to the service provider networks 454, 464, and 474, respectively. In some implementations, the profile servers 552, 562, and 572 may send the service provider profiles directly to the AP 102 (without the use of the profile proxy 540) in response to a user request or service activation. In some implementations, the AP 102 may obtain (such as during a software update) a list of service providers and uniform resource locations (URLs) to obtain the corresponding service provider profiles.

In some implementations, the service provider profiles may be used by the AP 102 to enable the service connectivity techniques in this disclosure. For example, the service provider profiles may include communication link or security information such as a NAI realm, predetermined SSID, service security key, among other examples. The AP 102 may advertise that it supports service connectivity to the service provider using the communication link or security information. A wireless device that is configured for a particular service provider may be preconfigured with corresponding communication link or security information which can be used to establish a communication link via the AP 102.

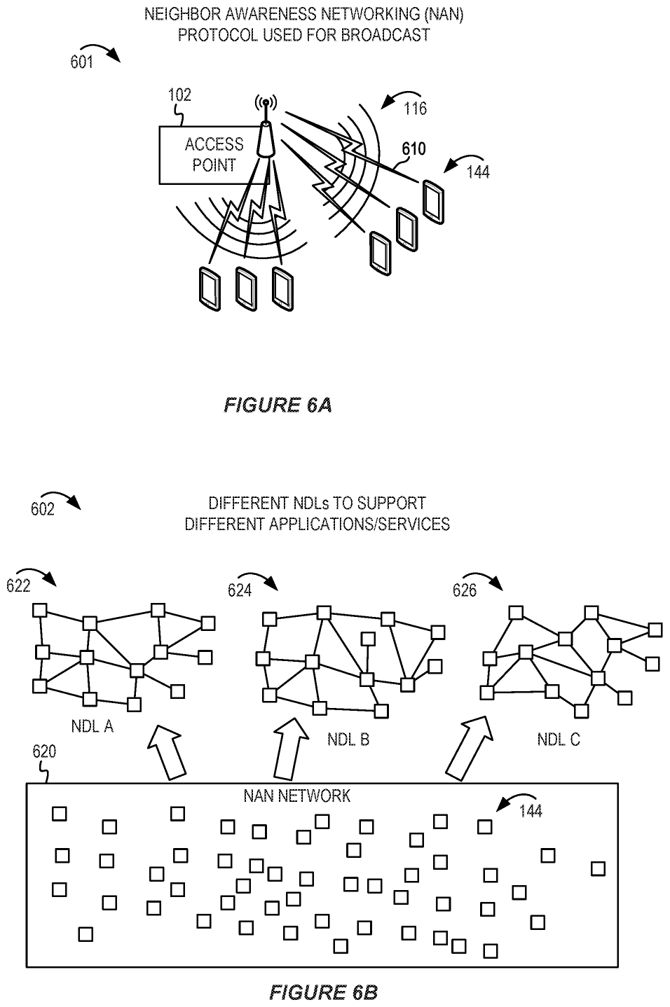

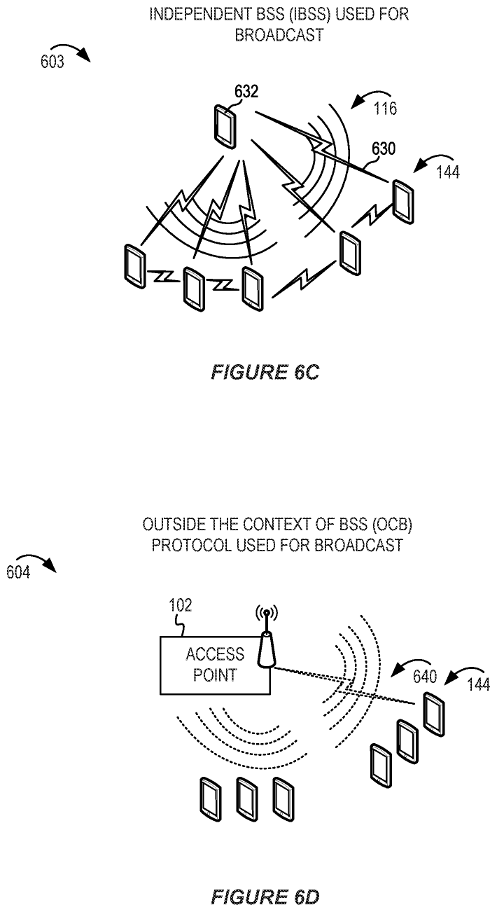

FIG. 6A shows a pictorial diagram of an example wireless communication network 601 using the NAN protocol for service connectivity. According to some aspects, the wireless communication network 601 can be an example of a WLAN. For example, the wireless communication network 601 can be a network implementing at least one of the IEEE 802.11 family of standards. The wireless network 601 may include multiple wireless devices (such as the wireless device 144).

Before explaining modifications to the neighbor awareness network (NAN) protocol to support service connectivity, it may be useful to describe the NAN protocol. The NAN protocol is not currently implemented in IEEE 802.11 networks. Rather, the NAN protocol is defined by the Wi-Fi Alliance (WFA) Neighbor Awareness Networking (also referred to as NAN) standard specification. NAN-compliant devices (hereinafter also simply “NAN devices”) transmit and receive NAN communications (for example, in the form of Wi-Fi packets including frames conforming to an IEEE 802.11 standard such as that defined by the IEEE 802.11-2016 specification or amendments thereof) to and from one another via NAN data links (NDLs) 610 (hereinafter also referred to as “NAN links”). A NAN network generally refers to a collection of NAN devices that share a common set of NAN parameters including: the time period between consecutive discovery windows (DWs), the time duration of the discovery windows, the NAN beacon interval, and the NAN discovery channel(s). A NAN ID is an identifier signifying a specific set of NAN parameters for use within the NAN network. NAN networks are dynamically self-organized and self-configured. Each NAN device may be configured to transmit two types of beacons: NAN discovery beacons and NAN synchronization beacons. When a NAN device is turned on, or otherwise when NAN-functionality is enabled, the NAN device periodically transmits NAN discovery beacons (for example, every 100 TUs, every 128 TUs or another suitable period) and NAN synchronization beacons (for example, every 512 TUs or another suitable period). Discovery beacons are management frames, transmitted between discovery windows, used to facilitate the discovery of NAN clusters. A NAN cluster is a collection of NAN devices within a NAN network that are synchronized to the same clock and discovery window schedule using a time synchronization function (TSF). To join NAN clusters, NAN devices passively scan for discovery beacons from other NAN devices. When two NAN devices come within a transmission range of one another, they will discover each other based on such discovery beacons. In traditional implementations, respective master preference values determine which of the NAN devices will become the master device. If a NAN cluster is not discovered, a NAN device may start a new NAN cluster. When a NAN device starts a NAN cluster, it assumes the master role and broadcasts a discovery beacon. Additionally, a NAN device may choose to participate in more than one NAN cluster within a NAN network.

The links between the NAN devices in a NAN cluster are associated with discovery windows—the times and channel on which the NAN devices converge. At the beginning of each discovery window, one or more NAN devices may transmit a NAN synchronization beacon, which is a management frame used to synchronize the timing of the NAN devices within the NAN cluster to that of the master device. The NAN devices may then transmit multicast or unicast NAN service discovery frames directly to other NAN devices within the service discovery threshold and in the same NAN cluster during the discovery window. The service discovery frames indicate services supported by the respective NAN devices.

In some such implementations, a NAN device may, in a service discovery frame, advertise an ability to provide such access point services to other NAN devices. There are two general NAN service discovery messages: publish messages and subscribe messages. Generally, publishing is a mechanism for an application on a NAN device to make selected information about the capabilities and services of the NAN device available to other NAN devices, while subscribing is a mechanism for an application on a NAN device to gather selected types of information about the capabilities and services of other NAN devices. A NAN device may generate and transmit a subscribe message when requesting other NAN devices operating within the same NAN cluster to provide a specific service. For example, in an active subscriber mode, a subscribe function executing within the NAN device may transmit a NAN service discovery frame to actively seek the availability of specific services. A publish function executing within a publishing NAN device capable of providing a requested service may, for example, transmit a publish message to reply to the subscribing NAN device responsive to the satisfaction of criteria specified in the subscribe message. The publish message may include a range parameter indicating the service discovery threshold, which represents the maximum distance at which a subscribing NAN device can avail itself of the services of the publishing NAN device. A NAN also may use a publish message in an unsolicited manner, for example, a publishing NAN device may generate and transmit a publish message to make its services discoverable for other NAN devices operating within the same NAN cluster. In a passive subscriber mode, the subscribe function does not initiate the transfer of any subscribe message, rather, the subscribe function looks for matches in received publish messages to determine the availability of desired services.

Subsequent to a discovery window is a transmission opportunity period. This period includes numerous resource blocks. A NAN data link (NDL) refers to the negotiated resource blocks between NAN devices used for NAN operations. An NDL can include more than one “hop.” The number of hops depends on the number of devices between the device providing the service and the device consuming or subscribing to the service. An example of an NDL that includes two hops includes three NAN devices: the provider, the subscriber and a proxy to relay the information between the provider and the subscriber. In such a configuration, the first hop refers to the communication of information between the provider and the proxy, and the second hop refers to the communication of the information between the proxy and the subscriber. An NDL may refer to a subset of NAN devices capable of one-hop service discovery, but an NDL also may be capable of service discovery and subscription over multiple hops (a multi-hop NDL).

There are two general NDL types: paged NDL (P-NDL) and synchronized NDL (S-NDL). Each common resource block (CRB) of a P-NDL includes a paging window (PW) followed by a transmission window (TxW). All NAN devices participating in a P-NDL operate in a state to receive frames during the paging window. Generally, the participating NAN devices wake up during the paging window to listen on the paging channel to determine whether there is any traffic buffered for the respective devices. For example, a NAN device that has pending data for transmission to another NAN device may transmit a traffic announcement message to the other NAN device during the paging window to inform the other NAN device of the buffered data. If there is data available, the NAN device remains awake during the transmission window to exchange the data. If there is no data to send, the NAN device may transition back to a sleep state during the transmission window to conserve power. A NAN device transmits a paging message to its NDL peer during a paging window if it has buffered data available for the peer. The paging message includes, for example, the MAC addresses or identifiers of the destination devices for which data is available. A NAN device that is listed as a recipient in a received paging message transmits a trigger frame to the transmitting device and remains awake during the subsequent transmission window to receive the data. The NDL transmitter device transmits the buffered data during the transmission window to the recipient devices from whom it received a trigger frame. A NAN device that establishes an S-NDL with a peer NAN device may transmit data frames to the peer from the beginning of each S-NDL CRB without transmitting a paging message in advance.

Some NAN networks may be a peer-to-peer (P2P), ad-hoc or mesh network. NAN devices may communicate directly with each other via P2P wireless links (without the use of an intermediary AP). In some implementations, the mesh network may use a data packet routing protocol, such as Hybrid Wireless Mesh Protocol (HWMP), for path selection. Each NAN device may be configured to relay data for the NAN network such that various NAN devices may cooperate in the distribution of data within the network. As a result, a message can be transmitted from a source NAN device to a destination NAN device by being propagated along a path, hopping from one NAN device to the next until the destination is reached.

Having described the NAN protocol in general, FIG. 6A will be described to explain how the NAN protocol may be modified and used in the IEEE 802.11 network to support service connectivity. For example, the AP 102 may create (or join) a NAN cluster to provide synchronization, service discovery and NDL formation. The AP 102 may establish communication links 610 with wireless devices. In some implementations, the NAN network 620 may be a one-to-many NDL. The AP 102 may advertise the presence of the broadcast communication links 610 for the broadcast service. In some implementations, the one-to-many NDL may be used for uplink broadcast frames, downlink broadcast frames, or both. In some implementations, such as a mesh network, the concept of “uplink” or “downlink” may be fluid.

In some implementations, the same one-to-many NDL may be shared by more than one broadcast service or by more than one wireless device. The wireless devices may participate in the NAN cluster and subscribe to the broadcast service using the broadcast communication links 610.

There may be multiple NDLs in operation in the NAN network. A wireless device may determine which NDL(s) to join based on a type of content. For example, a first wireless device that is executing an application to send data to a first service provider may join an NDL that is associated with that service provider. Similarly, a second wireless device may execute an application associated with a second service provider and may join an NDL associated with the second service provider. Each wireless device may select which NDL(s) or may join an AP for unicast or broadcast (or both) based on the applications executing at the wireless device.

FIG. 6B shows a pictorial diagram 602 in which a NAN network 620 may include different NDLs to support different applications or services. For example, the NAN network 620 may include multiple devices (such as the wireless device 144). Within the NAN network 620, there may exist different NDLs (such as a first NDL 622, a second NDL 624 and a third NDL 626). Each NDL may be associated with different applications or services (such as different service providers). In some implementations, the NDLs may form a NAN data link cluster (NDC) or may be referred to as separate NDL networks. In some implementations, the NDLs may be operated on different channels or different time blocks (or both).

FIG. 6C shows a pictorial diagram of an example wireless communication network 603 using an independent Basic Service Set (IBSS) for service connectivity. An IBSS is a mode of communication in which peer devices (such as STAs or IoT devices) can communicate directly with each other. Rather than using a unique BSSID (such as for an infrastructure mode BSS), an independent BSS may use a universal or group address. The broadcast signals 116 may be transmitted as IBSS addressed frames 630 over the IBSS from any of the peer devices. It should be apparent the that the peer devices in the IBSS may include APs, wireless devices (such as STAs or IoT devices, among other examples) or any combination thereof. In an IBSS, each of the participating peer devices may have a loose association with one or more other peer devices.

An initiator of the IBSS (such as an AP or a STA 632) may set up the IBSS and broadcast frames using the IBSS mode. Any devices (such as the wireless device 144) may operate in an IBSS mode to send or receive broadcast data. For example, the wireless device 144 may enable IBSS mode in response to determining that an AP or STA 632 provides service connectivity to a service provider using the IBSS. In some implementations, each device participating in IBSS mode are expected to contend to send a beacon transmission. However, this may lead to beacon collisions or hidden beacons in a larger network. In some implementations, the beacon behavior in a IBSS may be modified when the IBSS is used for broadcast services. For example, the initiator of a broadcast IBSS may beacon while the recipients of the broadcast may refrain from sending beacons in the IBSS mode. Other techniques may be used to determine which recipients (if any) may send beacons to maintain synchronization in the IBSS. In some implementations, the IBSS mode may be modified for use with broadcast services such that it would not be confused with a traditional IBSS. For example, the addressing, association, or other security feature may be used to prevent legacy STAs from attempting to join the IBSS unless they are interested in receiving the broadcast transmissions.

FIG. 6D shows a pictorial diagram of an example wireless communication network 604 using the OCB protocol for service connectivity. The OCB protocol, defined in IEEE 802.11p, may permit STAs to transmit data frames outside of the context of a BSS. For example, in the traditional use case for IEEE 802.11p, the STA would not be a member of a BSS. The OCB protocol may expect STAs to communicate directly over a wireless medium without the latency that may be associated with establishing a BSS. A setting in a management frame is used by a STA to indicate that it supports OCB protocol. Data frames have a wildcard BSS identifier (BSSID) value in a BSSID field that would otherwise identify a BSS. For example, the wildcard BSSID may be all “1s.”

In the example wireless communication network 604, the AP 102 may transmit broadcast frames 640 with data frames formatted according to the OCB protocol. For example, the BSSID field may be set to a wildcard BSSID value. Alternatively, another reserved BSSID value may be used to indicate that the broadcast frames 640 contain broadcast data. Each of the wireless devices (such as the wireless device 144) may receive the broadcast frames 640. In some implementations, the AP 102 may not establish a BSS and may refrain from transmitting beacon frames or probe response frames. The wireless device 144 may enable an OCB mode to establish a communication link with the AP 102 for communicating via the AP 102 to a service provider network.

Other variations of service connectivity are possible. For example, an AP may operate a dedicated BSS for uplink broadcast transmissions from wireless devices. In some implementations, the dedicated BSS may provide a fixed, always-available BSS for a first type of wireless device (such as for IoT devices associated with a particular vendor or entity). In some implementations, the dedicated BSS may be a concurrent BSS that is different from another BSS operated for other user devices (different from the first type of wireless device). The configuration of the dedicated BSS may be predetermined such that the first type of wireless device can be pre-configured by a manufacturer or vendor. Alternatively, the configuration of the dedicated BSS may be provided to first type of wireless device during on-boarding. In some implementations, the configuration for the dedicated BSS may be difficult or impractical for a homeowner or consumer to modify. The beacon interval for dedicated BSS may be much longer than a normal beacon interval associated with non-IoT BSSs. In some implementation, short FILS discovery (FD) frames may replace beacon frames since the configuration is fixed and there may not be much information to include in a beacon frame. The AP 102 may be configured to reject wireless association requests for the dedicated BSS that are received from a second type of wireless device (different from the first type of wireless device served by the dedicated BSS). For example, the frames from the wireless device may identify the device type.

In some implementations, a wireless device may utilize pre-configured settings to access a service via a WLAN. For example, a first type of wireless device may ship or be sold in a pre-authenticated (or pre-associated) state. The wireless device may send periodic ‘hello’ frames. The hello frames may be in the form of Vendor Specific Public Action frames. The new client may be in State 1 and may limit frames to Class 1 frames only. For example, IEEE standards may define which frames can be exchanged between an AP and a wireless device during different stages of association. State 1 may refer to an unassociated state and may limit frames to class 1 frames defined in the IEEE standards.

The techniques in this disclosure may be used by an AP that also provides service connectivity for other devices in a WLAN. For example, the AP may create or join a NAN cluster in addition to operating a private home BSS. The NAN cluster may be set up with default (pre-defined) parameters. The NAN protocol may provide synchronization, service discovery and NDL setup. In some implementations, the AP may advertise an ‘IoT gateway’ service to give new IoT devices a pathway to send the IoT sensor data (or other IoT communications) via the AP 102 to another apparatus. A new IoT device in the pre-authenticated state may send periodic ‘hello’ subscription message during a NAN discovery window (DW). The client device may establish an NDL with the AP to access the other apparatus. The AP may forward the IoT communications from the IoT device to the appropriate IoT service provider network (associated with the NDL). In some implementations, the AP also may forward downlink frames from the IoT service provider network to the IoT device (based on mapping)

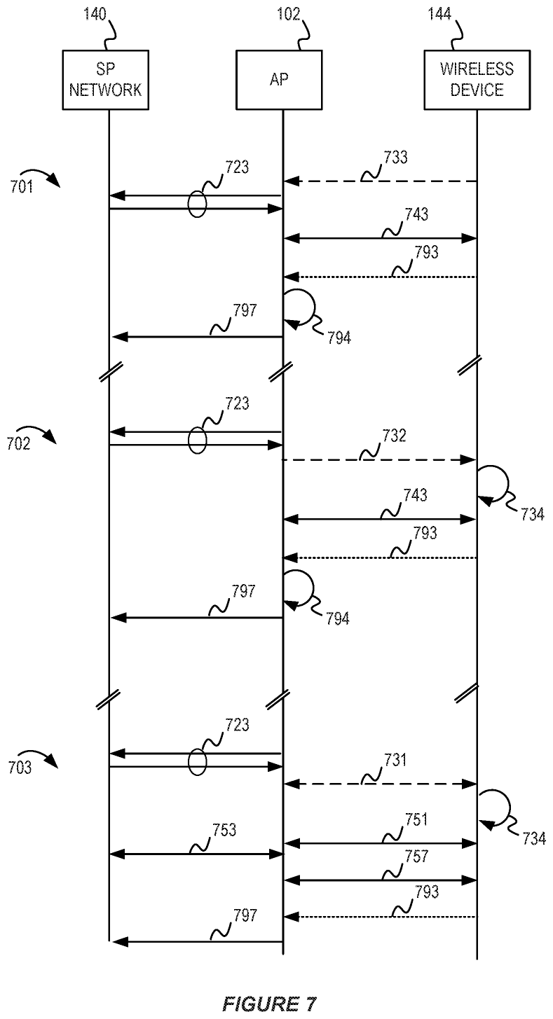

FIG. 7 shows a message flow diagram illustrating example service connectivity techniques. The first service connectivity technique 701 shows an example broadcast communication link that may be used for uplink traffic. For example, the wireless device 144 may send a hello message 733 to indicate that the wireless device 144 supports a pre-configured service parameter for a communication link to a service provider network 140. If the AP 102 does not already have the service provider profile for the service provider, the AP 102 may obtain the service provider profile from the service provider network 140. For example, the AP 102 may establish an on-demand relationship with the service provider network 140. In another example, the AP 102 may obtain the service provider profile prior to receiving the hello message 733. Service provider profile messages 723 may include one or more messages between the AP 102 and the service provider network 140 such that the AP 102 obtains the service provider profile. The service provider profile may include the pre-configured service parameter or a corresponding parameter. Using messages 743, the AP 102 and the wireless device 144 may establish service connectivity based on the pre-configured service parameter. Thereafter, the wireless device 144 may transmit uplink broadcast frames 793 to the AP 102. At operation 794, the AP 102 may determine where to forward the uplink broadcast frames. For example, the AP 102 may forward the uplink broadcast frames via a communication 797 (wired, wireless, or a combination of links) to a first service provider network 140.

The second service connectivity technique 702 shows another example broadcast communication link that may be used for uplink traffic. Using service provider profile messages 723, the AP 102 may obtain a service provider profile from the service provider network 140. The service provider profile may include a pre-configured service parameter or corresponding parameter to assist with establishing a communication link for a wireless device. The AP 102 may transmit a service advertisement message 732 to indicate that the service provider network 140 supports the pre-configured service parameter for a communication link. At operation 734, the wireless device 144 may determine that the service advertisement message 732 indicates support for the service provider associated with the wireless device 144. Using messages 743, the wireless device 144 may establish service connectivity via the AP 102 based on the pre-configured service parameter. Thereafter, the wireless device 144 may transmit uplink broadcast frames 793 to the AP 102. At block 794, the AP 102 may determine where to forward the uplink broadcast frames. For example, the AP 102 may forward the uplink broadcast frames via a communication 797 (wired, wireless, or a combination of links) to a first service provider network 140.

The third service connectivity technique 703 shows another example broadcast communication link that may be used for uplink traffic. Using service provider profile messages 723, the AP 102 may obtain a service provider profile from the service provider network 140. Using message 731, the wireless device 144 may determine that the AP 102 is capable of providing service connectivity to the service provider network 140. Message 731 may be a broadcast from either the AP 102 or the wireless device 144 or may be some other message that can indicate support for the service connectivity. The wireless device 144, the AP 102, and the service provider network 140 may exchange service request and response messages 751, 753, 757 to establish a communication link between the AP 102 and the wireless device 144. For example, the wireless device 144 may transmit a service request message 751 to the AP 102 and the AP 102 may forward the service request message 753 to the service provider network 140. Upon receiving approval from the service provider network 140, the AP 102 may respond to the wireless device 144 with approval 757. The service request and response messages 751, 753, and 757 may be configured for an EAP authentication procedure, a challenge-response authentication, or another authentication technique. In some implementations, the service request and response messages 751, 753, and 757 may include certificates or certificate-signed messages to verify the sender of the service request and response messages 751, 753, and 757. After completing the authentication phase, the wireless device 144 and the AP 102 may have established a communication link for the service connectivity between the wireless device 144 and the service provider network 140 via the AP 102. Thereafter, the wireless device 144 may transmit uplink broadcast frames 793 to the AP 102. In operation 794, the AP 102 may determine where to forward the uplink broadcast frames. For example, the AP 102 may forward the uplink broadcast frames via a communication 797 (wired, wireless, or a combination of links) to a first service provider network 140.

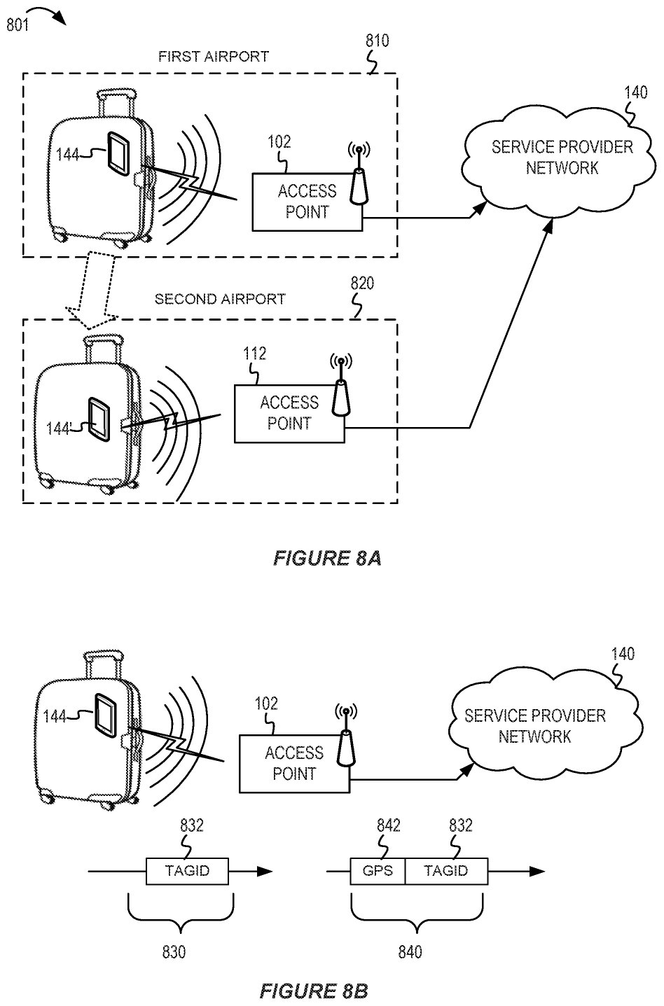

FIG. 8A shows a pictorial diagram 801 of an example use case of a mobile tracking sensor utilizing uplink broadcast services. In the pictorial diagram 801, the wireless device 144 may be a tracking device for tracking goods. For example, the wireless device 144 may be associated with luggage, goods, a shipment, among other examples. In the example of FIG. 8A, the wireless device 144 is associated with luggage that may be transported through one or more airports. Other examples may include a tracking device for use with a shipment of goods through a shipping and distribution entity. For example, a provider of goods may include a tracking device with an appliance shipped to a retail store or to a home or business location.

While the wireless device 144 is at a first airport 810, it may transmit an uplink broadcast communication that may then be received by a first AP 102. The first AP 102 may forward the uplink communication to service provider network 140. For example, the uplink communication from the wireless device 144 may include an address associated with the service provider network 140. As described above, the AP 102 may perform some authentication or establishment of the service associated with the service provider network 140.

Later, when the wireless device 144 (referred to as wireless device 144′) moves to a second airport 820, the wireless device 144′ may again broadcast an uplink communication. At second airport 820, a second AP 112 may receive the uplink communication and forward the uplink communication to the service provider network 140. Based on the uplink communications, the service provider network 140 may be able to determine a status or location of the wireless device 144. For example, the uplink communication may include location data determined by the wireless device 144. Alternatively, or additionally, the APs 102, 112 may be configured to append AP-provided data to the uplink communication as shown in FIG. 8B. For example, the AP-provided data may include location data, date stamps, timestamps, or received signal strength indicators (RSSIs) determined by the APs 102, 112.

FIG. 8B shows a pictorial diagram in which an AP may append additional information to a forwarded uplink message. FIG. 8B may be similar to the example in FIG. 8A. For brevity, the second AP 112 is omitted and FIG. 8B shows the wireless device 144 sending an uplink communication via the first AP 102. An uplink communication 830 from the wireless device 144 may include an identifier (such as a tag ID 832) associated with the wireless device 144. Because the wireless device 144 is a tracking device, it may be a low-cost and low-power transmitter with limited capabilities. For example, the wireless device 144 may not include GPS or other location-determination capabilities. However, the AP 102 may append AP-provided data to the uplink communication 830. For example, the AP 102 may have a GPS receiver or may be configured with a geographical or other physical location of the AP 102. When forwarding the uplink communication 830, the AP 102 may append the AP-provided data (shown as GPS data 842) to the tag ID 832. The forwarded communication 840 includes both the tag ID 832 and appended AP-provided data. Although described as appended data, the AP-provided data may be appended before, after, or in parallel to the original data.

In some other implementations, an address or identifier of the APs 102, 112 may be used by the service provider network 140 to determine a location of the wireless device 144. For example an internet protocol (IP) address of the APs 102, 112 may be included in the forwarded uplink communication to the service provider network 140.

The IP address may be appended as AP-provided data or may simply be used as the source address in a header of a packet that includes the forwarded uplink communication. Alternatively, an AP identifier may be appended as AP-provided data or in a wrapper of a packet that includes the forwarded uplink communication. The service provider network 140 may determine a location of the APs 102, 112 based on the IP address or AP identifier. In some implementations, the service provider network 140 may retrieve location of the AP from a database that cross-references the AP's IP address or AP identifier with the location of the AP. In some implementations, the service provider network 140 may have a partnership or other relationship with a vendor that deployed that APs 102, 112. The partnership or other relationship may include access to the database that cross-references the AP's IP address or AP identifier with the location of the AP. Alternatively, the service provider network 140 may determine a location of the AP based on a registry of IP addresses or based on a routing table entry (such as border gateway protocol (BGP-4) routing update or another inter-domain routing protocol update). There may be other techniques for the service provider network 140 to determine an approximate or exact location of the APs 102, 112. The service provider network 140 may use the obtained location data in combination with the forwarded uplink communication to determine an approximate or exact location of the wireless device 144.

In some implementations, the AP-provided data may be protected or obscured for security or privacy. For example, the AP-provided data may be digitally signed by the AP so that the service provider network 140 can verify that the AP-provided data is from an authorized AP. The signed AP-provided data may be signed or encrypted based on a security credential shared between the authorized AP and the service provider network 140. In some implementations, the AP-provided data may be formatted according to a format defined in a technical standard. Alternatively, the AP-provided data may be formatted according to a proprietary format used by the service provider network 140 and the authorized AP. In some implementation, the AP-provided data may be standard defined, specific to a particular service or category of sensor device, or may be based on the partnership between the service provider network 140 and the vendor that has deployed the AP.

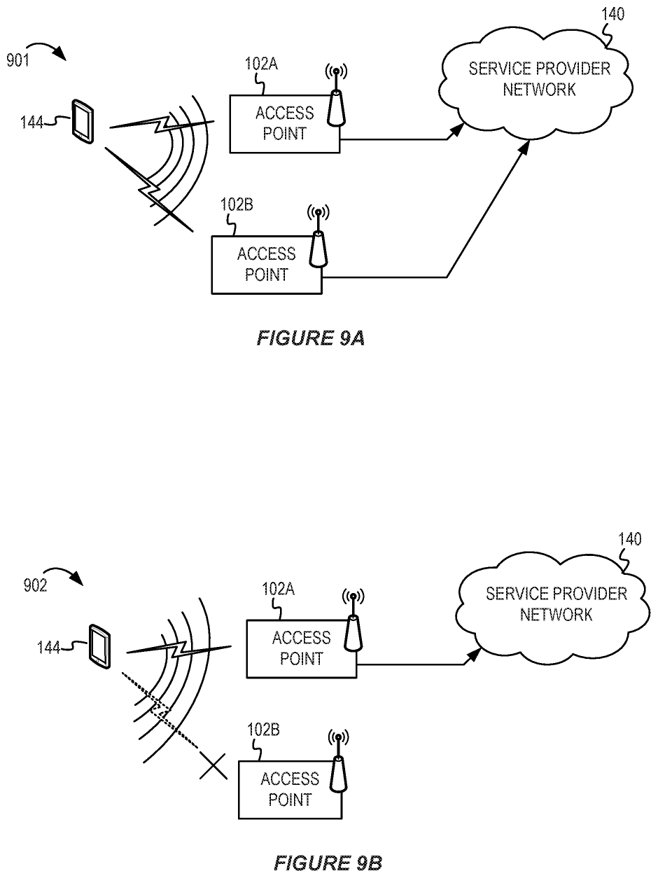

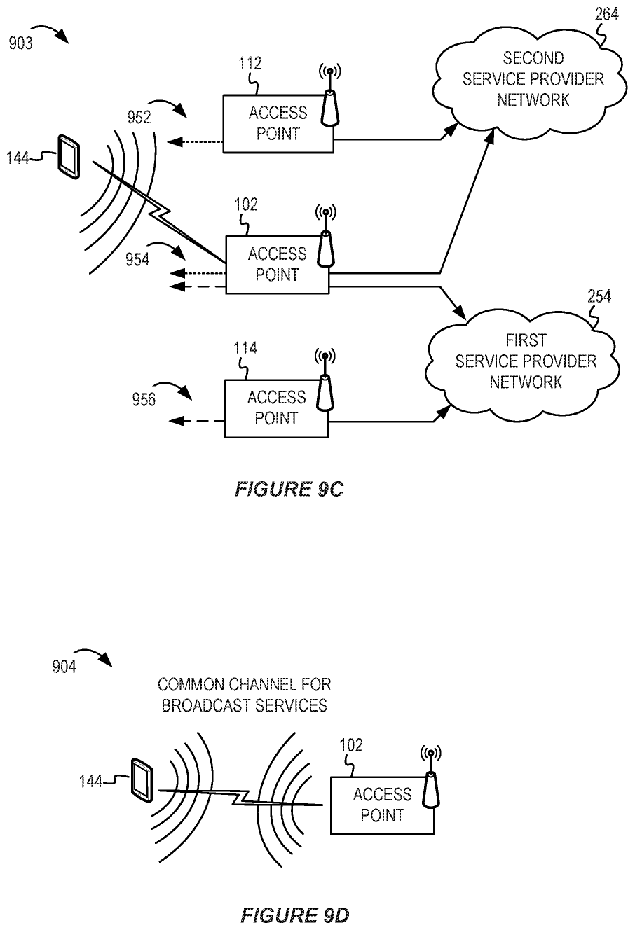

FIG. 9A shows a pictorial diagram 901 in which multiple APs may support uplink broadcast services. The wireless device 144 may be in a location where multiple APs 102A, 102B are capable of forwarding the uplink communication. If the APs 102A, 102B are both configured to append timestamp data to the uplink communication, the service provider network 140 may be configured to disregard an earlier or duplicate uplink communication.

FIG. 9B shows a pictorial diagram 902 in which different APs may differ in their support of uplink broadcast services. For example, a first AP 102A may support the uplink broadcast services described in this disclosure and a second AP 102B may not support the uplink broadcast services. The wireless device 144 may transmit uplink communications blindly to any APs within a vicinity of the wireless device 144. Alternatively, a protocol, such as those described herein, may be defined to assist the wireless device 144 and the multiple APs 102A, 102B to determine which AP supports (or is best suited for) the uplink broadcast techniques in this disclosure.

FIG. 9C shows a pictorial diagram 903 in which different APs may advertise their support of uplink broadcast services. A first AP 102 may support forwarding to a first service provider network 254 and to a second service provider network 264. The AP 102 may advertise which service providers are supported via one or more advertisement messages 954. Meanwhile, a second AP 112 may support a connection to only the second service provider network 264 and a third AP 114 may support a connection to only the first service provider network 254. Each of the APs 112 and 114 may advertise which service providers are supported in advertisement messages 952 and 956, respectively. In some implementations, the advertisement messages 952, 954, and 956 may be communicated via a common channel so that the wireless device 144 can quickly determine the services provided by each of the APs 102, 112, and 114.

In the example of FIG. 9C, the wireless device 144 may have uplink data to communicate to the first service provider network 254. The wireless device 144 may observe the advertisement messages 952, 954, and 956 to determine which APs support the first service provider network 254. Since the second AP 112 does not support the first service provider network 254, the wireless device 144 may direct the uplink communication to either the first AP 102 or the third AP 114. In some implementations, selection between the first and third APs 102 and 114 may be based on RSSI of the advertisement messages 954 and 956, respectively. In some implementations, the wireless device 144 may broadcast the uplink communication so that either of the first and third APs 102 and 114 may receive the uplink communication and forward it to the first service provider network 254.

FIG. 9D shows a pictorial diagram 904 in which a common channel may be used for broadcast services. The common channel may be one or more wireless channels that are predetermined to support uplink broadcast services. In some implementations, the common channel may be reserved for uplink broadcast services. Alternatively, the common channel may be used by an AP to establish a traditional BSS (in addition to or in lieu of the broadcast services described herein) if there are no APs in the vicinity that are using the common channel for uplink broadcast services.

In some implementations, at least one AP may broadcast service advertisement messages on the common channel to indicate which services are available. If multiple APs are available in the environment, the APs may share the common channel and send service advertisement messages at different times. In some implementations a first AP may aggregate service advertisement information from multiple neighboring APs and transmit an aggregated service advertisement message on the common channel.

A wireless device 144 may scan the common channel for a short amount of time to determine if there are any APs available to send uplink communications to a service provider via the common channel. The wireless device 144 may use the common channel for uplink broadcast messages. In some implementations, the APs (such as AP 102) may be configured to receive broadcasts via the common channel and forward the broadcasts to the destination service provider (not shown).

In some implementations, the common channel may be reserved for a particular service, category of service, or category of client devices. For example, the common channel may be reserved for use by tracking devices to send updates regarding the status or location of the tracking device. In another example, the common channel may be reserved for use by eBCS-capable devices. In another example, the service provider (not shown) may inform any subscribers of the service (such as the wireless device 144) to use a particular common channel. The service provider may establish a relationship with AP operators to have their APs (such as the AP 102) operate on the common channel for its service.

The use of a common channel may decrease power consumption or increase battery life of the wireless device 144. For example, if the wireless device 144 scans the common channel and determines that no APs are nearby, the wireless device 144 may decrease the periodicity of uplink broadcast transmissions. Furthermore, if the wireless device 144 determines that the same APs (such as the first AP 102) and RSSIs are detected, the wireless device 144 may determine that it is stationary and may decrease the periodicity of transmitting uplink broadcast location updates.

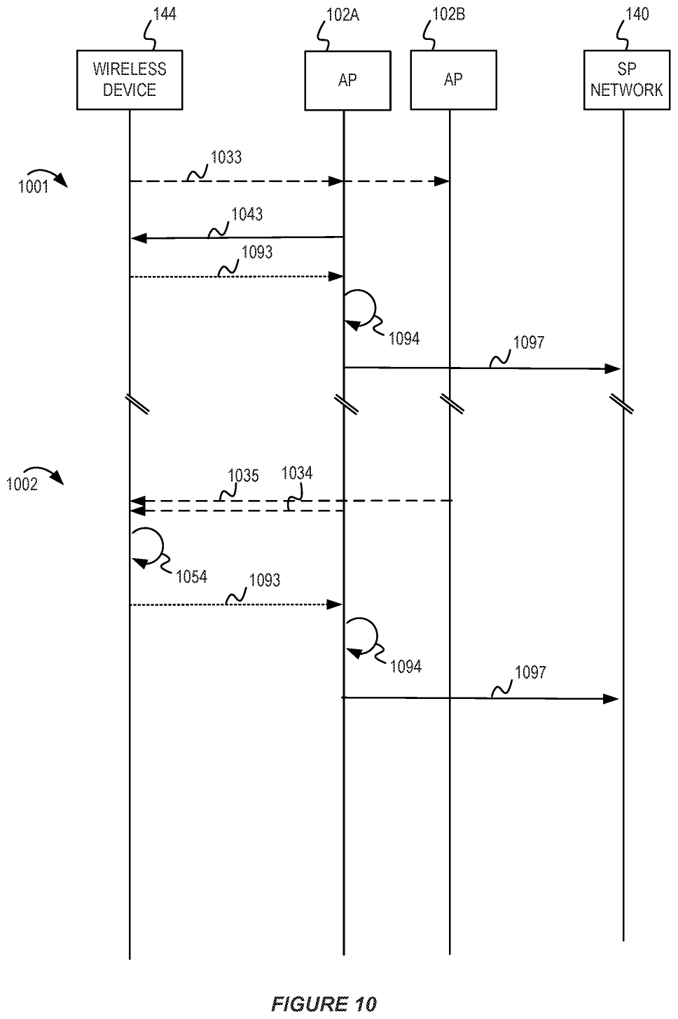

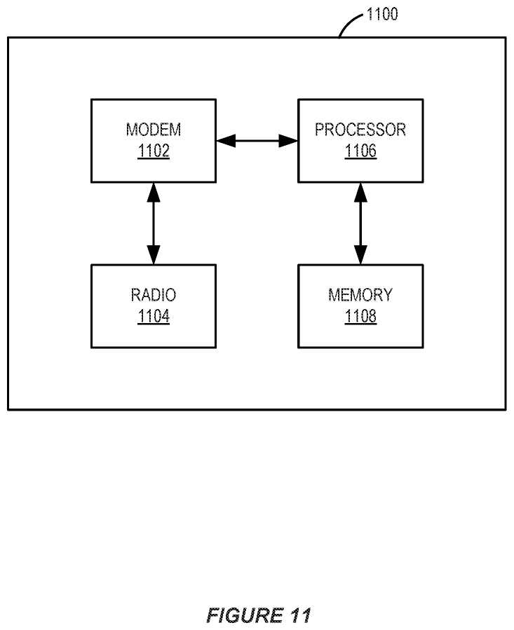

FIG. 10 shows a message flow diagram illustrating example uplink service connectivity techniques in an environment with multiple APs (including a first AP 102A and a second AP 102B). In a first example 1001, the wireless device 144 may trigger a procedure for determining and selecting an AP that supports uplink service connectivity. The wireless device 144 may send a service request message 1033 to indicate that the wireless device 144 is looking for an AP that supports a forwarding service to communicate with the service provider network 140. The service request message 1033 may be a broadcast message, such as a GAS message with an extension or a new frame type defined for eBCS. The service request message 1033 may indicate or include information to identify the desired service provider network 140. If the first AP 102A supports uplink service and forwarding to the service provider network 140, the first AP 102A may send a response message 1043 to the wireless device 144 to confirm that the first AP 102A supports uplink service to the service provider network 140. If the first AP 102A does not already have the service provider profile for the service provider, the first AP 102A may obtain the service provider profile from the service provider network 140 as described in FIG. 7. In some implementations, the first AP 102A may include a challenge nonce in the response message 1043.

The wireless device 144 may communicate the uplink communication 1093 to the first AP 102A. In some implementations, the uplink communication 1093 may include the uplink data as well as a response to the challenge nonce. The response to the challenge nonce may serve as basic authentication while also permitting the wireless device 144 to send the uplink communication without establishing a full wireless association with the first AP 102A. Note that in this example, the second AP 102B may not support the uplink service or may not support the particular service provider network 140. In another example, if both the first AP 102A and the second AP 102B send response messages (not shown), the wireless device 144 may select one of the first and second APs 102A, 102B based on, for example, the received signal strength of the response messages. For example, the wireless device 144 may select the AP that sent the response message having the strongest RSSI.

Returning to the first example 1001, the first AP 102A may receive the uplink communication 1093 and forward at least part of the uplink communication 1093 in a forwarded message 1097 to the service provider network 140. In some implementations, the first AP 102A may append (shown as operation 1094) AP-provided data to the uplink communication 1093 before forwarding it in the forwarded message 1097.

In a second example 1002, the APs 102A, 102B may trigger uplink services by advertising that they support the uplink service described herein. In this example, both the first and second APs 102A, 102B support uplink service to the service provider network 140. They may advertise that they support the uplink service. For example, both the APs may broadcast beacon messages (such as beacon messages 1034 and 1035 from the first and second APs 102A, 102B, respectively). In some implementations, each of the beacon messages may include a challenge nonce. The wireless device 144 may select (shown as operation 1054) the first AP 102A based on the beacon messages. For example, the wireless device 144 may determine that the first AP 102A is nearest or otherwise offers better connectivity by comparing the RSSI values associated with the beacon messages 1034 and 1035. Alternatively, or additionally, the wireless device 144 may select the first AP 102A based on other contents or indicators in the beacon message 1034 that indicates the first AP 102A supports the desired service provider network 140.

After selecting the first AP 102A, the wireless device 144 may transmit the uplink communication 1093 to the first AP 102A. The first AP 102A may receive the uplink communication 1093 and forward at least part of the uplink communication 1093 in a forwarded message 1097 to the service provider network 140. In some implementations, the first AP 102A may append (shown as operation 1094) AP-provided data to the uplink communication 1093 before forwarding it in the forwarded message 1097.

As described above, wireless devices and APs may use different service connectivity techniques than previously used with WLAN wireless associations. For example, the time and messaging overhead typical required for establishing a wireless association may be impractical for some services as described herein. In some deployments, the establishment of communication links may benefit from new types of service connectivity techniques, including broadcast services.

Various implementations relate generally to wireless communication. Some implementations more specifically relate to service connectivity techniques in a wireless network. In some implementations, a communication protocol may be modified or adapted to enable service connectivity using broadcast services. A service provider profile may be used to establish or enforce policies at an AP. The service provider profile also may enable establishment of a communication link for a wireless device and may enable security features associated with service connectivity.

Particular implementations of the subject matter described in this disclosure can be implemented to realize one or more of the following potential advantages. Wireless devices can be deployed using new onboarding and service connectivity techniques. Adoption of new types of devices (such as IoT devices or non-traditional client device) can be more user friendly as a result of the efficient onboarding. Security can be implemented at an AP based on service provider profiles. Thus, the risks to the WLAN and the upstream networks can be mitigated. Meanwhile, some of the implementations can enable seamless onboarding with little or no user configuration.

FIG. 11 shows a block diagram of an example wireless communication device 1100. In some implementations, the wireless communication device 1100 can be an example of a device for use in a STA such as one of the STAs 104, 144 described herein. In some implementations, the wireless communication device 1100 can be an example of a device for use in an AP such as the AP 102 described herein. The wireless communication device 1100 is capable of transmitting (or outputting for transmission) and receiving wireless communications (for example, in the form of wireless packets). For example, the wireless communication device 1100 can be configured to transmit and receive packets in the form of physical layer convergence protocol (PLCP) protocol data units (PPDUs) and Media Access Control (MAC) protocol data units (MPDUs) conforming to an IEEE 802.11 standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 1100 can be, or can include, a chip, system on chip (SoC), chipset, package or device that includes one or more modems 1102, for example, a Wi-Fi (IEEE 802.11 compliant) modem. In some implementations, the one or more modems 1102 (collectively “the modem 1102”) additionally include a WWAN modem (for example, a 3GPP 4G LTE or 5G compliant modem). In some implementations, the wireless communication device 1100 also includes one or more radios 1104 (collectively “the radio 1104”). In some implementations, the wireless communication device 1106 further includes one or more processors, processing blocks or processing elements 1106 (collectively “the processor 1106”) and one or more memory blocks or elements 1108 (collectively “the memory 1108”).

The modem 1102 can include an intelligent hardware block or device such as, for example, an application-specific integrated circuit (ASIC) among other possibilities. The modem 1102 is generally configured to implement a PHY layer. For example, the modem 1102 is configured to modulate packets and to output the modulated packets to the radio 1104 for transmission over the wireless medium. The modem 1102 is similarly configured to obtain modulated packets received by the radio 1104 and to demodulate the packets to provide demodulated packets. In addition to a modulator and a demodulator, the modem 1102 may further include digital signal processing (DSP) circuitry, automatic gain control (AGC), a coder, a decoder, a multiplexer and a demultiplexer. For example, while in a transmission mode, data obtained from the processor 1106 is provided to a coder, which encodes the data to provide encoded bits. The encoded bits are then mapped to points in a modulation constellation (using a selected MCS) to provide modulated symbols. The modulated symbols may then be mapped to a number N_{SS} of spatial streams or a number N_{STS} of space-time streams. The modulated symbols in the respective spatial or space-time streams may then be multiplexed, transformed via an inverse fast Fourier transform (IFFT) block, and subsequently provided to the DSP circuitry for Tx windowing and filtering. The digital signals may then be provided to a digital-to-analog converter (DAC). The resultant analog signals may then be provided to a frequency upconverter, and ultimately, the radio 1104. In implementations involving beamforming, the modulated symbols in the respective spatial streams are precoded via a steering matrix prior to their provision to the IFFT block.

While in a reception mode, digital signals received from the radio 1104 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may then be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are then fed to the demultiplexer for demultiplexing. The demultiplexed bits may then be descrambled and provided to the MAC layer (the processor 1106) for processing, evaluation or interpretation.

The radio 1104 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may in turn be coupled to one or more antennas. For example, in some implementations, the wireless communication device 1100 can include, or be coupled with, multiple transmit antennas (each with a corresponding transmit chain) and multiple receive antennas (each with a corresponding receive chain). The symbols output from the modem 1102 are provided to the radio 1104, which then transmits the symbols via the coupled antennas. Similarly, symbols received via the antennas are obtained by the radio 1104, which then provides the symbols to the modem 1102.

The processor 1106 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 1106 processes information received through the radio 1104 and the modem 1102, and processes information to be output through the modem 1102 and the radio 1104 for transmission through the wireless medium. For example, the processor 1106 may implement a control plane and MAC layer configured to perform various operations related to the generation and transmission of MPDUs, frames or packets. The MAC layer is configured to perform or facilitate the coding and decoding of frames, spatial multiplexing, space-time block coding (STBC), beamforming, and OFDMA resource allocation, among other operations or techniques. In some implementations, the processor 1106 may generally control the modem 1102 to cause the modem to perform various operations described above.

The memory 1106 can include tangible storage media such as random-access memory (RAM) or read-only memory (ROM), or combinations thereof. The memory 1104 also can store non-transitory processor- or computer-executable software (SW) code containing instructions that, when executed by the processor 1106, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

In some implementations, the wireless communication device 1100 may include a broadcast services transmit unit (not shown). The broadcast services transmit unit may be similar to the broadcast services transmit unit 120 described with reference to FIG. 2 and may implement any of the broadcast services feedback techniques described herein. In some implementations, the broadcast services support unit may be implemented by a processor 1106 and a memory 1108. The memory 1108 can include computer instructions executable by the processor 1106 to implement the functionality of the broadcast services support unit. Any of these functionalities may be partially (or entirely) implemented in hardware or on the processor 1106.

In some implementations, the wireless communication device 1100 may include an uplink broadcast support unit (not shown). The uplink broadcast support unit may be similar to the uplink broadcast support unit 150 described with reference to FIG. 2 and may implement any of the uplink broadcast techniques described herein. In some implementations, the uplink broadcast support unit may be implemented by a processor 1106 and a memory 1108. The memory 1108 can include computer instructions executable by the processor 1106 to implement the functionality of the uplink broadcast support unit. Any of these functionalities may be partially (or entirely) implemented in hardware or on the processor 1106.

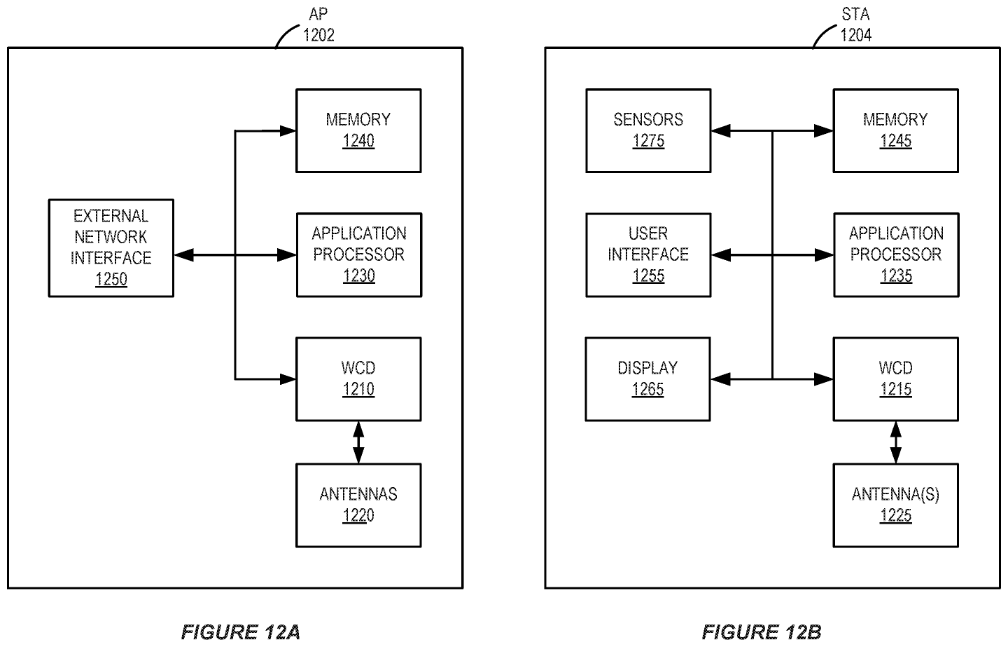

FIG. 12A shows a block diagram of an example AP 1202. For example, the AP 1202 can be an example implementation of the AP 102 described herein. The AP 1202 includes a wireless communication device (WCD) 1210. For example, the wireless communication device 1210 may be an example implementation of the wireless communication device 1100 described with reference to FIG. 11. The AP 1202 also includes multiple antennas 1220 coupled with the wireless communication device 1210 to transmit and receive wireless communications. In some implementations, the AP 1202 additionally includes an application processor 1230 coupled with the wireless communication device 1210, and a memory 1240 coupled with the application processor 1230. The AP 1202 further includes at least one external network interface 1250 that enables the AP 1202 to communicate with a core network or backhaul network to gain access to external networks including the Internet. For example, the external network interface 1250 may include one or both of a wired (for example, Ethernet) network interface and a wireless network interface (such as a WWAN interface). Ones of the aforementioned components can communicate with other ones of the components directly or indirectly, over at least one bus. The AP 1202 further includes a housing that encompasses the wireless communication device 1210, the application processor 1230, the memory 1240, and at least portions of the antennas 1220 and external network interface 1250.

FIG. 12B shows a block diagram of an example STA 1204. For example, the STA 1204 can be an example implementation of the STA 104, 144 described herein. The STA 1204 includes a wireless communication device 1215. For example, the wireless communication device 1215 may be an example implementation of the wireless communication device 1100 described with reference to FIG. 11. The STA 1204 also includes one or more antennas 1225 coupled with the wireless communication device 1215 to transmit and receive wireless communications. The STA 1204 additionally includes an application processor 1235 coupled with the wireless communication device 1215, and a memory 1245 coupled with the application processor 1235. In some implementations, the STA 1204 further includes a user interface (UI) 1255 (such as a touchscreen or keypad) and a display 1265, which may be integrated with the UI 1255 to form a touchscreen display. In some implementations, the STA 1204 may further include one or more sensors 1275 such as, for example, one or more inertial sensors, accelerometers, temperature sensors, pressure sensors, or altitude sensors. Ones of the aforementioned components can communicate with other ones of the components directly or indirectly, over at least one bus. The STA 1204 further includes a housing that encompasses the wireless communication device 1215, the application processor 1235, the memory 1245, and at least portions of the antennas 1225, UI 1255, and display 1265.

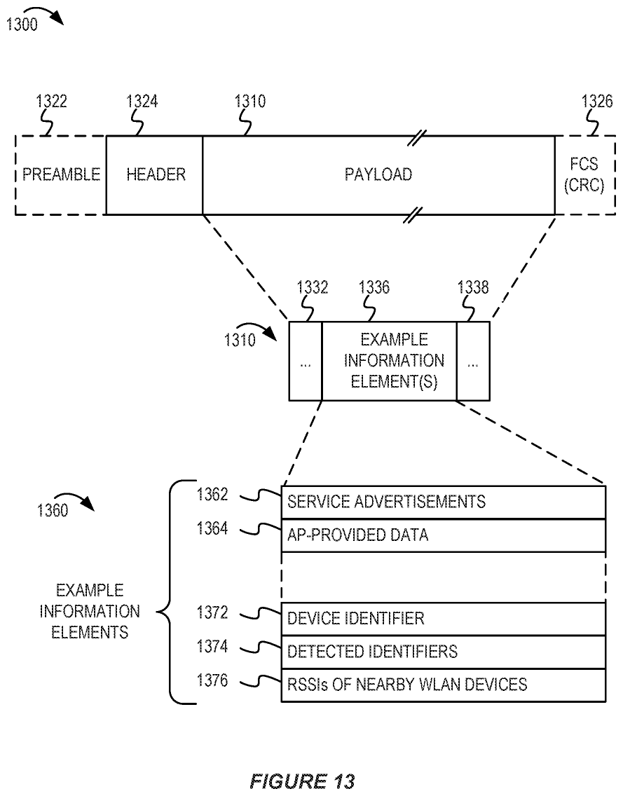

FIG. 13 depicts a conceptual diagram of an example frame for broadcast services. For example, the example frame 1300 may be sent from an AP to a wireless device or from a wireless device to an AP. In some implementations, the example frame 1300 may include, or be included in, a configuration message. The example frame 1300 may be defined by the IEEE 802.11 specification. In some implementations, the example frame 1300 may be based on a generic advertisement services (GAS) message frame format that is modified or extended to include capability or configuration information to support uplink broadcast services. In some other implementations, the example frame 1300 may be a new frame format created to facilitate broadcast services. One example of the example frame 1300 may include an enhanced beacon frame that may be used by IEEE 802.11 (similar to the beacon frames defined for IEEE 802.11ax). Another example of an example frame 1300 may be a synchronization frame or other short frame that may be defined for other technologies (or next generation of IEEE 802.11, beyond 802.11ax).

The example frame 1300 may include a header 1324 and a payload 1310. In some implementations, the header 1324 may include a source address (such as the network address of the sending AP), the length of data frame, or other frame control information. The payload 1310 may be used to convey the broadcast services capability or configuration information. The broadcast services capability or configuration information may be organized or formatted in a variety of ways.

In some implementations, the example frame 1300 may include a preamble 1322. The preamble 1322 may be used, for example, when the transmission is non-triggered or non-scheduled. In some implementations, the preamble may be omitted for triggered or scheduled transmissions. When the preamble is present, the preamble 1322 may include one or more bits to establish synchronization. The example frame 1300 may include an optional frame check sequence (FSC) 1326. The payload 1310 may be organized with a message format and may include information elements 1332, 1336, and 1338.

Several examples of information elements 1360 are illustrated in FIG. 13. The information elements 1360 may include service advertisements 1362. For example, the service advertisements 1362 may indicate which service providers, service types, or eBCS services are available from an AP. In some implementations, the AP may send AP-provided data 1364 which can be observed by a wireless device. Other example information elements 1360 may be included in an uplink communication from a wireless device. For example, the information elements 1360 may include a device identifier (1372) (such as a TAG ID or other identifier recognized by the service provider), detected identifiers 1374, and RSSIs of nearby WLAN devices 1376. For example, the detected identifiers 1374 may be used by the service provider to determine more information about nearby WLAN devices from an identifier fingerprinting database. The RSSIs may be used to improve a location determination of the wireless device.

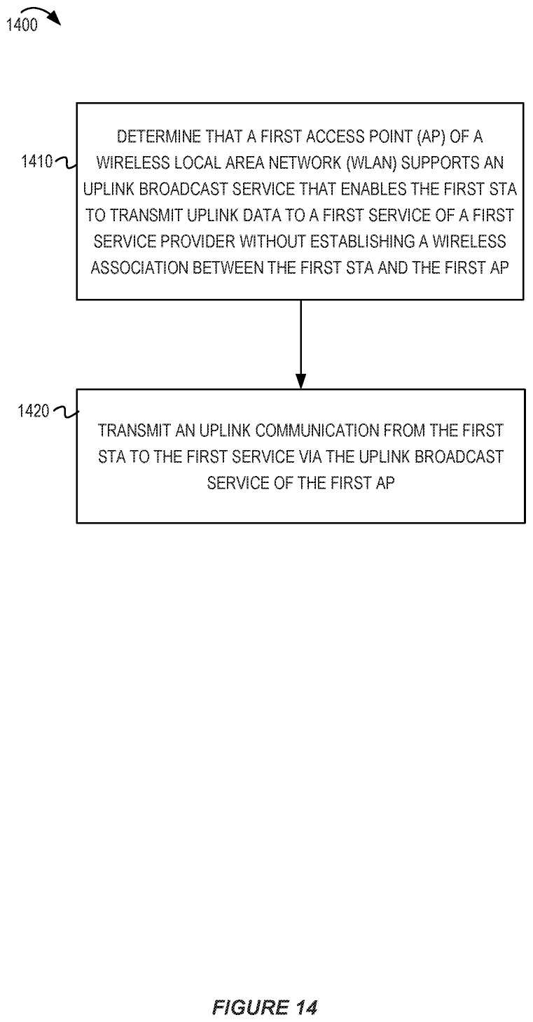

FIG. 14 shows a flowchart illustrating an example process 1400 for connecting to services. In some implementations, the process 1400 may be performed by a wireless communication device such as one of the STAs 104, 144, or 1204, or wireless communication devices 1100, 1215 described herein. In some implementations, the process 1400 begins in block 1410 with determining that a first access point (AP) of a wireless local area network (WLAN) supports an uplink broadcast service that enables the first STA to transmit uplink data to a first service of a first service provider without establishing a wireless association between the first STA and the first AP. For example, the wireless communication device may determine that the first AP is capable of providing service connectivity to a first service of a first service provider associated with the wireless communication device. In block 1420, the process 1400 proceeds with transmitting an uplink communication from the first STA to the first service via the uplink broadcast service of the first AP.

In some implementations, determining that the first AP supports the uplink broadcast service in block 1410 may include detecting a SSID associated with the first service. For example, the first AP may use a predetermined SSID associated with the service provider such that the wireless communication device (for example, a STA or IoT device) can determine that the first AP is configured with the service provider.

In some implementations, determining that the first AP supports the uplink broadcast service in block 1410 may include receiving a service advertisement from the first AP. For example, the service advertisement may indicate that the first AP is capable of providing the service connectivity to the first service. In some implementations, the service advertisement may include an NAI realm associated with the first service.

In some implementations, determining that the first AP supports the uplink broadcast service in block 1410 may include broadcasting a first frame to indicate that the wireless communication device supports a pre-configured service parameter for the first service. The wireless communication device may receive a response or other communication from the first AP which informs the wireless communication device that the pre-configured service parameter is supported.

In some implementations, determining that the first AP supports the uplink broadcast service in block 1410 may include receiving a beacon frame from the first AP that indicates that the first AP supports the pre-configured service parameter for the first service.

In some implementations, transmitting the uplink communication in block 1420 may include accessing a broadcast service of the first AP. For example, the broadcast service may include a NAN protocol, OCB protocol, MSS protocol, or other connectivity protocol which can be used without a traditional one-to-one wireless association.

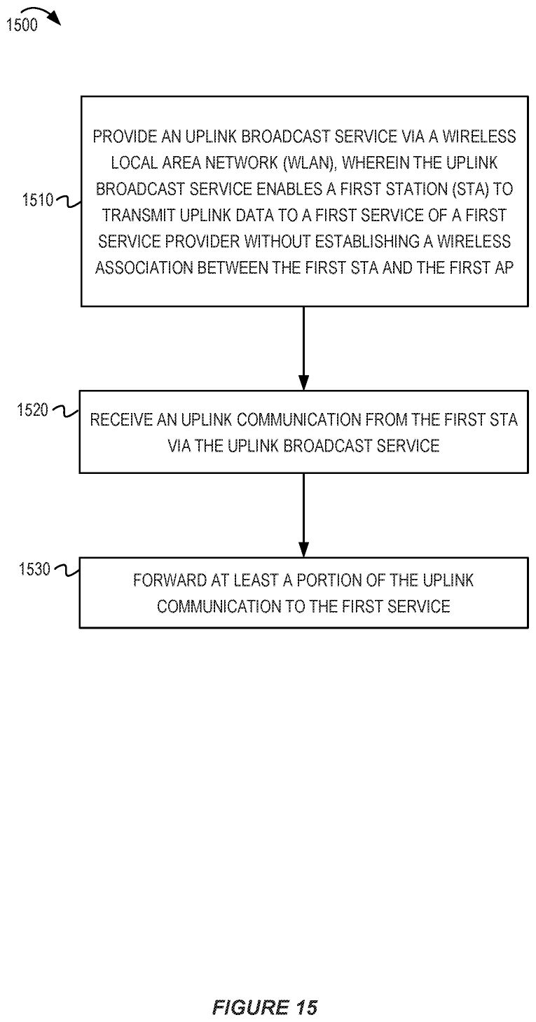

FIG. 15 shows a flowchart illustrating another example process 1500 for providing service connectivity to services. In some implementations, the process 1500 may be performed by a wireless communication device such as one of the APs 102, 1202 or the wireless communication devices 1202, 1210 described herein. In some implementations, the process 1500 begins in block 1510 with providing an uplink broadcast service via a wireless local area network (WLAN), wherein the uplink broadcast service enables a first station (STA) to transmit uplink data to a first service of a first service provider without establishing a wireless association between the first STA and the first AP.

In block 1520, the process 1500 proceeds with receiving an uplink communication from the first STA via the uplink broadcast service. For example, the wireless communication device may determine that a first wireless device is attempting to communicate with a first service of a first service provider. The wireless communication device may establish a communication link with the first wireless device in response to determining that the first wireless device is attempting to communicate with the first service of the first service provider. The wireless communication device may receiver one or more wireless messages from the first wireless device via the communication link. In block 1540, the process 1500 proceeds with forwarding at least a portion of the uplink communication to the first service.

In some implementations, determining that the first wireless device is attempting to communicate with the first service may include receiving a first frame from the first wireless device to indicate that the first wireless device supports a pre-configured service parameter for the first service.

In some implementations, establishing a communication link with the first wireless device may include receiving a service request message from the first wireless device. The service request message may include at least a client identifier for the first wireless device and a network access identifier (NAI) realm (or domain name) for the first service.

In some implementations, forwarding at least a portion of the uplink communication to the first service in block 1530 may include the first AP appending AP-provided data to the one or more wireless messages before forwarding at least a portion of the one or more wireless messages to the first service.

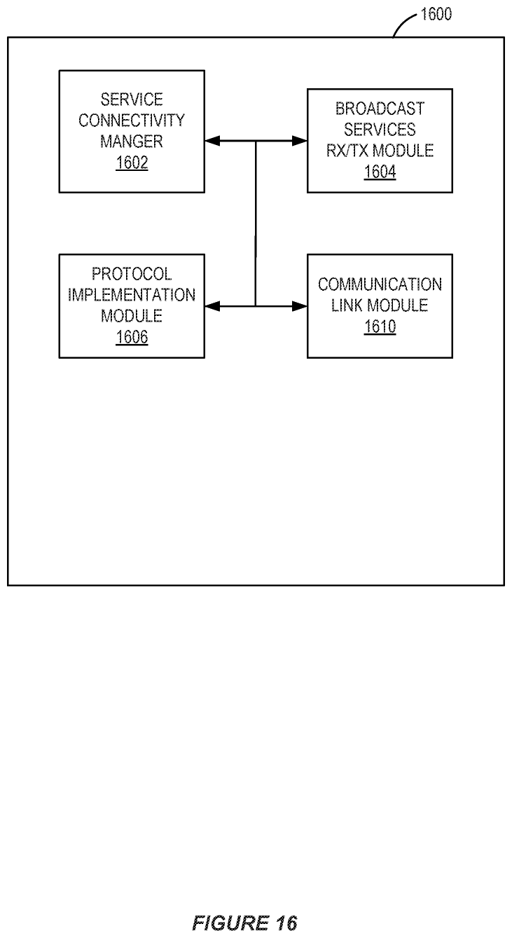

FIG. 16 shows a block diagram of an example wireless communication device 1600 for use in wireless communication. In some implementations, the wireless communication device 1600 can be an example of the STA 104, 144, 1204 or the wireless communication devices 1100, 1215 described herein. In some implementations, the wireless communication device 1600 can be an example of the AP 102, 1202 or wireless communication devices 1100, 1210. In some implementations, the wireless communication device 1600 is configured to perform one or more of the processes 1400 and 1500 described above with reference to FIGS. 14 and 15, respectively. The wireless communication device 1600 includes a service connectivity manager 1602, a broadcast services receive or transmit module 1604, a protocol implementation module 1606, and a communication link module 1610. Portions of one or more of the modules 1602, 1604, 1606 and 1610 may be implemented at least in part in hardware or firmware. For example, the broadcast services receive or transmit module 1604 may be implemented at least in part by one or more modems (for example, a Wi-Fi (IEEE 802.11) modem). In some implementations, at least some of the modules 1602, 1604, 1606 and 1610 are implemented at least in part as software stored in a memory (such as the memory 1106, 1240, or 1245). For example, portions of one or more of the modules 1602, 1604, 1606 and 1610 can be implemented as non-transitory instructions (or “code”) executable by at least one processor (such as the processor 1106) to perform the functions or operations of the respective module.

The service connectivity manager 1602 may manage the service connectivity capabilities of an AP or a wireless device. For example, the service connectivity manager 1602 may manage which type of service connectivity technique(s) are implemented in a WLAN. The service connectivity manager 1602 may advertise capabilities indicators to inform other wireless communication devices which service connectivity capabilities are enabled in the wireless communication device 1600. For example, the service connectivity manager 1602 may be similar to the uplink broadcast support unit 150 or the broadcast services support unit 120 described above. The broadcast services receive or transmit module 1604 may implement a broadcast connectivity protocol. The protocol implementation module 1606 may implement the NAN protocol or the OCB protocol. For example, the protocol implementation module 1606 may modify the NAN protocol or the OCB protocol as needed by the broadcast services receive or transmit module 1604. The communication link module 1610 may maintain a wireless association or an affiliation status between the wireless communication device 1600 and another wireless communication device.

FIGS. 1-16 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for wireless communication by a wireless communication device of a first wireless station (STA) comprising:
determining that a first access point (AP) of a wireless local area network (WLAN) supports an uplink broadcast service that enables the first STA to transmit uplink data to a first service of a first service provider without establishing a wireless association between the first STA and the first AP; and
transmitting an uplink communication from the first STA to the first service via the uplink broadcast service of the first AP.

2. The method of claim 1, wherein determining that the first AP supports the uplink broadcast service includes receiving a service advertisement from the first AP, the service advertisement indicating that the first AP is capable of forwarding the uplink communication to the first service.

3. The method of claim 2, wherein receiving the service advertisement includes receiving a beacon frame from the first AP that includes the service advertisement.

4. The method of claim 2, wherein receiving the service advertisement includes receiving a generic advertisement service (GAS) message from the first AP that includes the service advertisement.

5. The method of claim 2, wherein receiving the service advertisement includes receiving the service advertisement on a common channel associated with the uplink broadcast service.

6. The method of claim 2, wherein the service advertisement includes a network access identifier (NAI) realm or a domain name associated with the first service.

7. The method of claim 1, wherein determining that the first AP supports the uplink broadcast service includes detecting a service set identifier (SSID) associated with the first service.

8. The method of claim 1, wherein determining that the first AP supports the uplink broadcast service includes at least one member selected from a group consisting of:
broadcasting a first frame from the first STA to indicate that the first STA supports a pre-configured service parameter for the first service; and
receiving a beacon frame from the first AP that indicates that the first AP supports the pre-configured service parameter for the first service.

9. The method of claim 1, further comprising:
determining that a second AP supports a different uplink broadcast service associated with a second service; and
selecting the first AP in response to a determination that the first STA is associated with the first service.

10. The method of claim 1, wherein transmitting the uplink communication includes transmitting one or more broadcast frames from the first STA to a server associated with the first service via the first AP.

11. The method of claim 1, further comprising transmitting a first message to the first AP, the first message including at least a client identifier for the first STA and a network access identifier (NAI) realm for the first service.

12. The method of claim 1, wherein the first STA is a headless device that has pre-configured service parameters associated with the first service, and wherein the pre-configured service parameters are associated with a first configuration of the first AP that remains consistent regardless of whether the first AP implements an additional configuration for the WLAN.

13. The method of claim 1, wherein the uplink broadcast service includes a neighbor awareness network (NAN) protocol, and wherein transmitting the uplink communication includes joining a NAN data link (NDL) with the first AP.

14. The method of claim 13, wherein the NDL utilizes a pre-configured service parameter for the uplink broadcast service, the pre-configured service parameter providing uplink broadcast access for the first STA.

15. The method of claim 1, wherein the uplink broadcast service includes an outside context of a basic service set (OCB) protocol, and wherein transmitting the uplink communication includes transmitting one or more OCB wireless broadcast frames.

16. The method of claim 1, wherein the uplink broadcast service includes an independent basic service set (IBSS), and wherein transmitting the uplink communication includes determining that the first AP is operating the IBSS for the uplink broadcast service.

17. The method of claim 1, wherein transmitting the uplink communication includes transmitting the uplink communication without establishing a full wireless association between the first STA and the first AP.

18. A wireless communication device for use in a first station (STA) comprising:
at least one processor; and
at least one memory communicatively coupled with the at least one processor and storing processor-readable code that, when executed by the at least one processor, causes the wireless communication device to perform operations comprising:
determining that a first access point (AP) of a wireless local area network (WLAN) supports an uplink broadcast service that enables the first STA to transmit uplink data to a first service of a first service provider without establishing a wireless association between the first STA and the first AP, and
transmitting an uplink communication from the first STA to the first service via the uplink broadcast service of the first AP.

19. The wireless communication device of claim 18, wherein determining that the first AP supports the uplink broadcast service includes receiving a service advertisement from the first AP, the service advertisement indicating that the first AP is capable of forwarding the uplink communication to the first service.

20. The wireless communication device of claim 19, wherein receiving the service advertisement includes receiving a beacon frame from the first AP that includes the service advertisement.

21. The wireless communication device of claim 19, wherein receiving the service advertisement includes receiving a generic advertisement service (GAS) message from the first AP that includes the service advertisement.

22. The wireless communication device of claim 19, wherein receiving the service advertisement includes receiving the service advertisement on a common channel associated with the uplink broadcast service.

23. The wireless communication device of claim 19, wherein the service advertisement includes a network access identifier (NAI) realm or a domain name associated with the first service.

24. The wireless communication device of claim 18, wherein determining that the first AP supports the uplink broadcast service includes detecting a service set identifier (SSID) associated with the first service.

25. The wireless communication device of claim 18, wherein determining that the first AP supports the uplink broadcast service includes at least one member selected from a group consisting of:
broadcasting a first frame from the first STA to indicate that the first STA supports a pre-configured service parameter for the first service; and
receiving a beacon frame from the first AP that indicates that the first AP supports the pre-configured service parameter for the first service.

26. The wireless communication device of claim 18, wherein transmitting the uplink communication includes transmitting one or more broadcast frames from the first STA to a server associated with the first service via the first AP.

27. The wireless communication device of claim 18, wherein the first STA is a headless device that has pre-configured service parameters associated with the first service, and wherein the pre-configured service parameters are associated with a first configuration of the first AP that remains consistent regardless of whether the first AP implements an additional configuration for the WLAN.

28. The wireless communication device of claim 18, wherein the uplink broadcast service includes an outside context of a basic service set (OCB) protocol, and wherein transmitting the uplink communication includes transmitting one or more OCB wireless broadcast frames.

29. The wireless communication device of claim 18, wherein transmitting the uplink communication includes transmitting the uplink communication without establishing a full wireless association between the first STA and the first AP.

30. A mobile station comprising:
a wireless communication device comprising:
at least one processor, and
at least one memory communicatively coupled with the at least one processor and storing processor-readable code that, when executed by the at least one processor, causes the wireless communication device to perform operations comprising:
determining that a first access point (AP) of a wireless local area network (WLAN) supports an uplink broadcast service that enables the mobile station to transmit uplink data to a first service of a first service provider without establishing a wireless association between the mobile station and the first AP, and
transmitting an uplink communication from the mobile station to the first service via the uplink broadcast service of the first AP;
at least one transceiver coupled to the wireless communication device;
at least one antenna coupled to the at least one transceiver to wirelessly transmit signals output from the at least one transceiver and to wirelessly receive signals for input into the at least one transceiver; and
a housing that encompasses the wireless communication device, the at least one transceiver and at least a portion of the at least one antenna.

31-60. (canceled)
